(19) United States
(12) Patent Application Publication
(10) Pub. No.: US 2023/0130004 A1
(43) Pub. Date: Apr. 27, 2023

(54) RELEASE LAYER COMPOSITION FOR TRANSFER OF COMPONENTS

(71) Applicant: Terecircuits Corporation, Mountain View, CA (US)

(72) Inventor: Dillon M. Love, Mountain View, CA (US)

(21) Appl. No.: 17/820,482

(22) Filed: Aug. 17, 2022

Related U.S. Application Data
(60) Provisional application No. 63/234,406, filed on Aug. 18, 2021.

(51) Int. Cl. C09J 7/40

(52) U.S. Cl. CPC C09J 7/401; C09J 7/403; C09J 2301/502; C09J 2301/416; C09J 2203/326; C09J 2469/005; C09J 2471/005

(57) ABSTRACT

Release layers that include an oligomeric component comprising a unit of the Formula (I) are useful for releasably transferring components from one surface to another during manufacturing of microelectronic devices.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57, and Rules 4.18 and 20.6. U.S. Provisional Application No. 63/234,406, filed Aug. 18, 2021, is hereby incorporated by reference in its entirety.

### BACKGROUND

### Field

This disclosure relates to release layers used to releasably transfer components from one surface to another during manufacturing of microelectronic devices.

### Description of the Related Art

The transfer of microelectronic objects from one surface to another pervades processes of assembly and packaging of functional products, whether they are purely electronic (as in computer motherboards), optoelectronic (as in displays), sensors, or actuators. The physics of patterning systems limits the size of the system that can be made in one integrated parallel process, and process compatibility limits the type of materials. Thus useful systems require integration at the packaging level.

Integrated circuits, which allow various components (e.g., passive components) to be fabricated with the same techniques as transistors, allowed entire functional circuits to be made with parallel processing; that is, the simultaneous processing of an area, rather than a device. Today much of the innovation in microelectronics is centered on packaging, and specifically heterogeneous packaging. This means that many different types of integrated technologies (silicon ICs—digital or analog, compound semiconductor ICs and light emitters and receivers, microelectromechanical sensors, and other devices and systems) are put together in novel ways which achieve greater performance.

Although many techniques have recently been used for processing and packaging microelectronics, such as serial pick-and-place, laser ablation, stamps and adhesives, there remains a need for further advances in the art.

### SUMMARY

For purposes of summarizing the disclosure and the advantages achieved over the prior art, certain objects and advantages of the disclosure are described herein. Not all such objects or advantages may be achieved in any particular embodiment. Thus, for example, those skilled in the art will recognize that the invention may be embodied or carried out in a manner that achieves or optimizes one advantage or group of advantages as taught herein without necessarily achieving other objects or advantages as may be taught or suggested herein.

Various embodiments provide a release layer formulation, comprising an oligomeric component that comprises a unit of the Formula (I) and/or Formula (II):

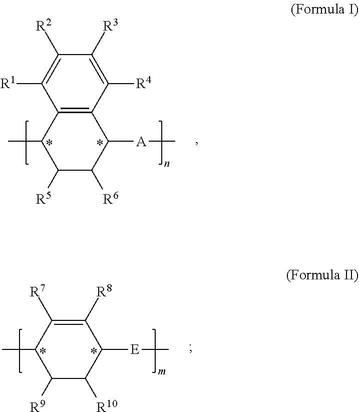

wherein:
each * denotes a chiral carbon;
n and m are independently an integer in the range of 1 to 15;
each A and E are independently —O—, —NH—,

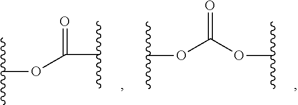 [SMILES: *OC(*)=O ; *OC(=O)O*]

an optionally substituted

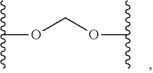 [SMILES: *OCO*]

an optionally substituted

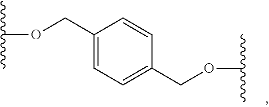 [SMILES: *OCc1ccc(CO*)cc1]

an optionally substituted

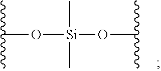 [SMILES: *O[Si](C)(C)O*]

an optionally substituted

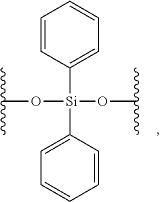 [SMILES: *O[Si](O*)(c1ccccc1)c1ccccc1]

an optionally substituted

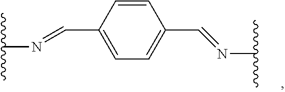 [SMILES: */N=C/c1ccc(/C=N/*)cc1]

an optionally substituted

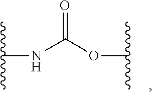 [SMILES: *NC(=O)O*]

an optionally substituted

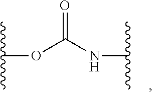 [SMILES: *NC(=O)O*]

an optionally substituted

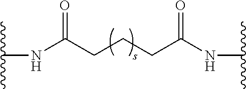

or an optionally substituted

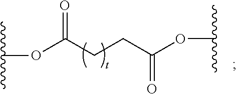

each R¹, R², R³, R⁴, R⁵, R⁶, R⁷, R⁸, R⁹ and R¹⁰ are independently hydrogen, halogen or C₁₋₃ alkyl; and
each s and t are independently an integer in the range of 1 to 10.

Various embodiments provide a release layer composition, comprising an oligomeric component that comprises a unit of the Formula (I) and/or Formula (II):

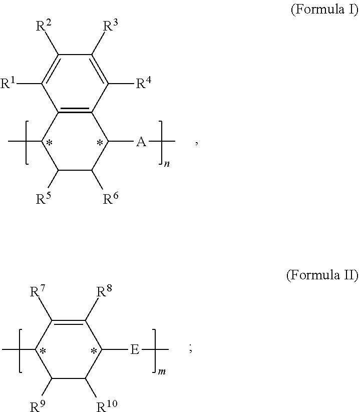

wherein:
each * denotes a chiral carbon;
n and m are independently an integer in the range of 1 to 15;
each A and E are independently —O—, —NH—,

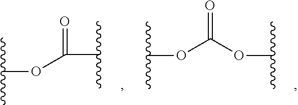 [SMILES: *OC(*)=O ; *OC(=O)O*]

an optionally substituted

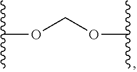 [SMILES: *OCO*]

an optionally substituted

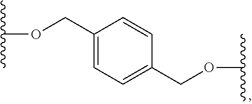 [SMILES: *OCc1ccc(CO*)cc1]

an optionally substituted

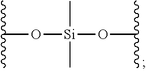 [SMILES: *O[Si](C)(C)O*]

an optionally substituted

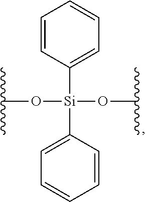 [SMILES: *O[Si](O*)(c1ccccc1)c1ccccc1]

an optionally substituted

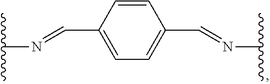 [SMILES: */N=C/c1ccc(/C=N/*)cc1]

an optionally substituted

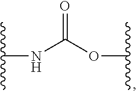 [SMILES: *NC(=O)O*]

an optionally substituted

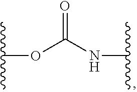 [SMILES: *NC(=O)O*]

an optionally substituted

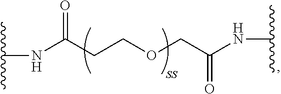

an optionally substituted

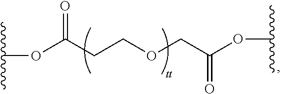

an optionally substituted

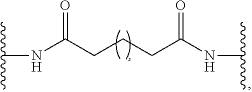

or an optionally substituted

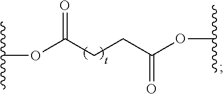

each R¹, R², R³, R⁴, R⁵, R⁶, R⁷, R⁸, R⁹ and R¹⁰ are independently hydrogen, halogen, C₁₋₁₀ alkyl, C₂₋₁₀ alkenyl or C₂₋₁₀ alkynyl; and
each ss, tt, s and t are independently an integer in the range of 1 to 10.

In some embodiments, R¹, R², R³, R⁴, R⁵, R⁶, R⁷, R⁸, R⁹ and R¹⁰ are hydrogen. In some embodiments, the release layer composition further comprises a polymeric component intermixed with the oligomeric component. In some embodiments, the oligomeric component is present in the release layer composition in an amount that is greater than the amount of the polymeric component on a weight basis.

In some embodiments, the polymeric component comprises a unit of the formula (III) and/or Formula (IV):

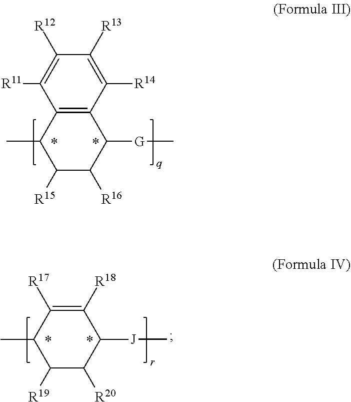

wherein:
each * denotes a chiral carbon;
q and r are independently an integer in the range of 16 to 200;
each G and J are independently —O—, —NH—,

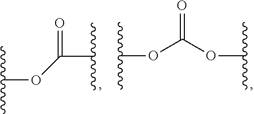

an optionally substituted

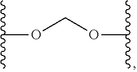 [SMILES: *OCO*]

an optionally substituted

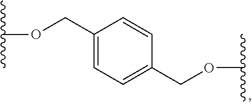 [SMILES: *OCc1ccc(CO*)cc1]

an optionally substituted

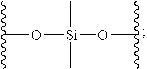 [SMILES: *O[Si](C)(C)O*]

an optionally substituted

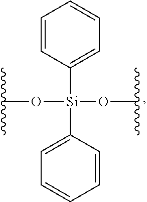 [SMILES: *O[Si](O*)(c1ccccc1)c1ccccc1]

an optionally substituted

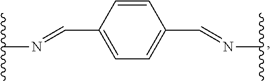 [SMILES: */N=C/c1ccc(/C=N/*)cc1]

an optionally substituted

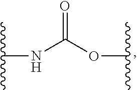 [SMILES: *NC(=O)O*]

an optionally substituted

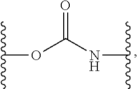 [SMILES: *NC(=O)O*]

an optionally substituted

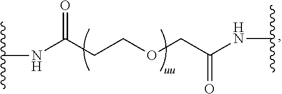

an optionally substituted

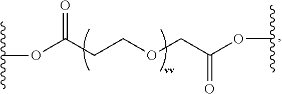

an optionally substituted

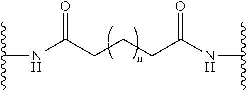

or an optionally substituted

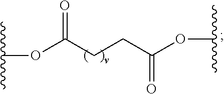

each R¹¹, R¹², R¹³, R¹⁴, R¹⁵, R¹⁶, R¹⁷, R¹⁸, R¹⁹ and R²⁰ are independently hydrogen, halogen, C₁₋₁₀ alkyl, C₂₋₁₀ alkenyl or C₂₋₁₀ alkynyl; and
each uu, vv, u and v are independently an integer in the range of 1 to 10.

In some embodiments, R¹¹, R¹², R¹³, R¹⁴, R¹⁵, R¹⁶, R¹⁷, R¹⁸, R¹⁹ and R²⁰ are hydrogen. In some embodiments, the chiral carbons in Formula (I) and Formula (II) are selected so that the oligomeric component has a cis:trans ratio in a range from about 20:80 to about 80:20. In some embodiments, the oligomeric component comprises a number averaged molecular weight (Mn) of about 1000-5000 g/mol. In some embodiments, the oligomeric component comprises a weight averaged molecular weight (Mw) of about 2000-7000 g/mol. In some embodiments, the Mw:Mn ratio of the oligomeric component is about 1:1 to 4:1. In some embodiments, the oligomeric component comprises a glass transition temperature (T_{g}) of about −50-200 ° C.

In some embodiments, the release layer composition further comprises an amount of a catalyst that is effective to catalyze decomposition of the oligomeric component in the presence of radiation. In some embodiments, the catalyst comprises an acid catalyst, a base catalyst, or a combination thereof. In some embodiments, the acid catalyst is a photoacid generator (PAG). In some embodiments, the release layer formulation comprises about 1-20 wt % of the catalyst.

In some embodiments, the release layer composition further comprises an amount of a thermal sensitizing agent that is effective to enhance the decomposition rate of the oligomeric component in the presence of radiation. In some embodiments, the release layer composition further comprises an amount of a low molecular weight additive that vaporizes under conditions at which the oligomeric component decomposes in the presence of radiation.

Various embodiments provide a release layer comprising a release layer formulation.

Various embodiments provide an assembly, comprising a release layer disposed over a donor plate. In some embodiments, the assembly further comprises a plurality of components in contact with the release layer.

Various embodiments provide a method of forming a transfer assembly, comprising:
disposing a release layer over a donor plate, wherein the release layer comprises an oligomeric component that comprises a unit of the Formula (I) and/or Formula (II):

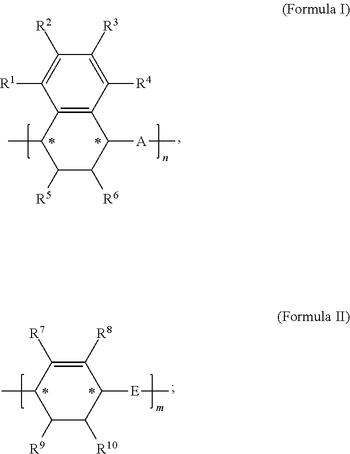

wherein:
each * denotes a chiral carbon;
n and m are independently an integer in the range of 1 to 15;
each A and E are independently —O—, —NH—,

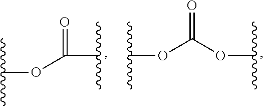

an optionally substituted

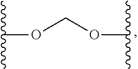 [SMILES: *OCO*]

an optionally substituted

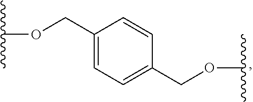 [SMILES: *OCc1ccc(CO*)cc1]

an optionally substituted

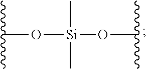 [SMILES: *O[Si](C)(C)O*]

an optionally substituted

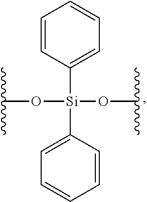 [SMILES: *O[Si](O*)(c1ccccc1)c1ccccc1]

an optionally substituted

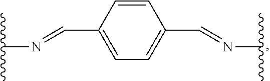 [SMILES: */N=C/c1ccc(/C=N/*)cc1]

an optionally substituted

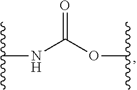 [SMILES: *NC(=O)O*]

an optionally substituted

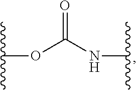 [SMILES: *NC(=O)O*]

an optionally substituted

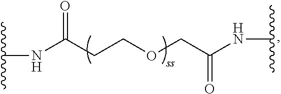

an optionally substituted

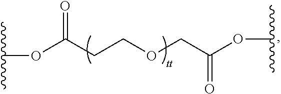

an optionally substituted

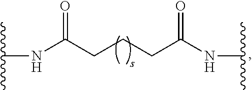

or an optionally substituted

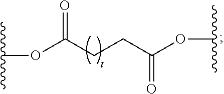

each R¹, R², R³, R⁴, R⁵, R⁶, R⁷, R⁸, R⁹ and R¹⁰ are independently hydrogen, halogen, C₁₋₁₀ alkyl, C₂₋₁₀ alkenyl or C₂₋₁₀ alkynyl; and
each ss, tt, s and t are independently an integer in the range of 1 to 10;
   and
contacting the release layer with a plurality of components to form the transfer assembly.

Various embodiments provide a method of transferring a plurality of components, comprising:
disposing a transfer assembly over a receiving substrate, wherein the transfer assembly comprises a donor plate, a release layer disposed over the donor plate, and a plurality of components in contact with the release layer, and wherein the release layer comprises an oligomeric component that comprises a unit of the Formula (I) and/or Formula (II):

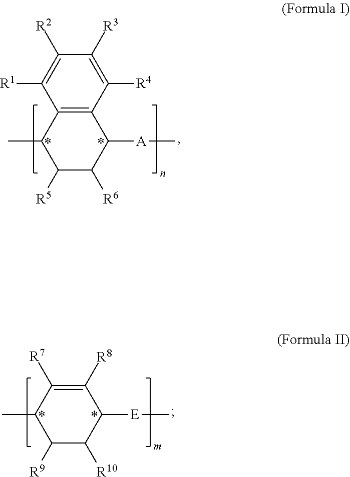

wherein:
each * denotes a chiral carbon;
n and m are independently an integer in the range of 1 to 15;
each A and E are independently —O—, —NH—,

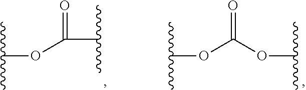 [SMILES: *OC(*)=O ; *OC(=O)O*]

an optionally substituted

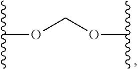 [SMILES: *OCO*]

an optionally substituted

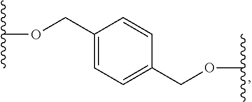 [SMILES: *OCc1ccc(CO*)cc1]

an optionally substituted

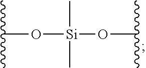 [SMILES: *O[Si](C)(C)O*]

an optionally substituted

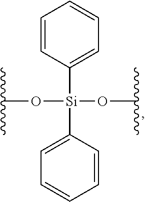 [SMILES: *O[Si](O*)(c1ccccc1)c1ccccc1]

an optionally substituted

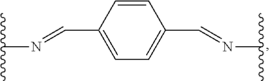 [SMILES: */N=C/c1ccc(/C=N/*)cc1]

an optionally substituted

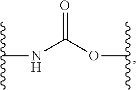 [SMILES: *NC(=O)O*]

an optionally substituted

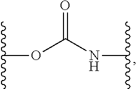 [SMILES: *NC(=O)O*]

an optionally substituted

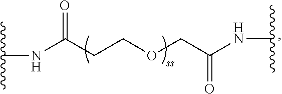

an optionally substituted

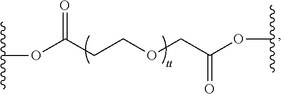

an optionally substituted

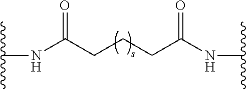

or an optionally substituted

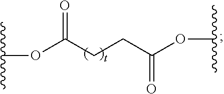

each R¹, R², R³, R⁴, R⁵, R⁶, R⁷, R⁸, R⁹ and R¹⁰ are independently hydrogen, halogen, C₁₋₁₀ alkyl, C₂₋₁₀ alkenyl or C₂₋₁₀ alkynyl; and
each ss, tt, s and t are independently an integer in the range of 1 to 10;
exposing portions of the release layer in contact with the plurality of components to a radiation source;
heating the release layer; and
degrading the portions of the release layer in contact with the plurality of components thereby transferring the plurality of components to the receiving substrate.

These and other embodiments are described in greater detail below.

### BRIEF DESCRIPTION OF THE DRAWINGS

These and other features, aspects, and advantages of the present disclosure are described with reference to the drawings of certain embodiments, which are intended to illustrate certain embodiments and not to limit the invention.

FIG. 1 illustrates an embodiment of a process flow in which a release layer composition (B) is used to transfer components (C) from an optically transparent donor plate (A) to a target substrate (D).

FIG. 2 illustrates examples of embodiments of monomeric carbonate structures.

FIG. 3 illustrates examples of dimeric, trimeric, oligomeric and polymeric carbonate structures.

FIG. 4 illustrates examples of oligomeric or polymeric component as block co-oligomers/polymers.

FIG. 5 depicts H-NMR spectra of 1,1′-(1,2,3,4-Tetrahydro-1,4-naphthalenediyl) di-1H-imidazole-1-carboxylate (top) and its 1,4-dihydroxy-1,2,3,4-tetrahydronaphthalene precursor (bottom).

FIG. 6 depicts a gel permeation chromatography trace with a UV and refractive index detector used for determination of molecular weight distribution of a synthesized polymer, according to some embodiments.

FIG. 7 depicts an H-NMR spectrum and proton assignments for a polymer, according to some embodiments.

FIG. 8 depicts a graph showing film thicknesses for polymers coated at variable spin rates, according to some embodiments.

FIG. 9 depicts an image of a polymer film coated on a fused silica substrate, according to some embodiments.

FIG. 10 depicts thermogravimetric analysis curves for the decomposition of release layer formulation before and after UV irradiation, according to some embodiments.

FIG. 11 depicts a gas chromatography (GC) retention curve of the decomposition products of a release layer formulation, according to some embodiments.

FIG. 12A depicts a pyrolysis-GC-FTIR of a decomposition products of a release layer formulation at an early time, according to some embodiments.

FIG. 12B depicts a pyrolysis-GC-FTIR of a decomposition products of a release layer formulation at a later time, according to some embodiments

FIG. 13A depicts an image of a 3D height data profile of the craters obtained by laser profilometry of a release layer heated after irradiation, according to some embodiments.

FIG. 13B depicts an image of a 3D height data profile of the craters obtained by laser profilometry of a release layer heated after irradiation, according to some embodiments.

FIG. 13C depicts an image of a 3D height data profile of the craters obtained by laser profilometry of a release layer heated after irradiation, according to some embodiments.

FIG. 14A depicts an image of a 3D height data profile of the craters obtained by laser profilometry of a release layer heated during irradiation, according to some embodiments.

FIG. 14B depicts an image of a 3D height data profile of the craters obtained by laser profilometry of a release layer heated during irradiation, according to some embodiments.

FIG. 15 depicts an image of silicon chip components attached to a release layer, according to some embodiments.

FIG. 16A depicts an image of microLED components disposed over a donor plate with a release layer after laser induced forward transfer, according to some embodiments.

FIG. 16B depicts an image of microLED components disposed over a target substrate after laser induced forward transfer from the donor plate shown in FIG. 16A, according to some embodiments.

FIG. 17A depicts an image of silicon die component transferred from a donor plate comprising a release layer onto a target substrate, according to some embodiments.

FIG. 17B depicts an image of silicon die component transferred from a donor plate comprising a release layer onto a target substrate enlarged from that shown in FIG. 17A, according to some embodiments.

### DETAILED DESCRIPTION

In various embodiments a release layer composition as described herein may be used in a process for transferring and/or packaging semiconductor components. The release layer composition may enable one to simultaneously place as many components on a surface as desired, limited only by how large one wants to make the mechanical fixture for the substrates. These components can range in size from microns (such as microLEDs) up to centimeters (such as large ICs).

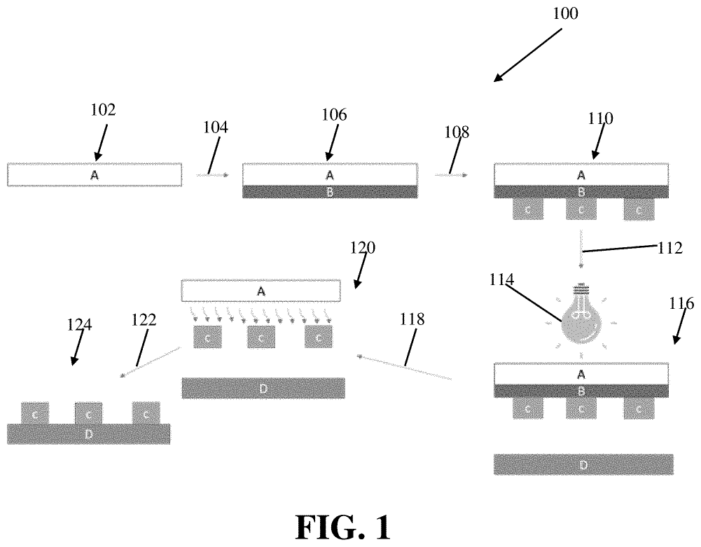

The use of a release layer composition as described herein in a transfer process 100 is illustrated in FIG. 1. In the illustrated process flow, an optically transparent donor plate (A) is provided 102 and coated 104 (e.g., solvent coated) with a film of the release layer composition (B) to form a coated donor plate 106. Then the desired components (C) to be transferred are adhered 108 to the release layer (B) of the coated donor plate 106 by bringing the components (C) and release layer (B) into contact with applied pressure and/or heat to form a component loaded donor plate 110. In some embodiments, components are attached to a carrier substrate (e.g., tape) prior to being loaded onto the release layer. In some embodiments, uniform pressure may be applied to the carrier substrate and/or donor plate. In some embodiments, a pressure of, of about, of at most, or of at most about 500 N/cm², 1000 N/cm², 1500 N/cm², 2000 N/cm², 2250 N/cm², 2500 N/cm², 2750 N/cm², 3000 N/cm², 3250 N/cm², 3350 N/cm², 3750 N/cm² or 4000 N/cm², or any range of values therebetween is applied to the carrier substrate and/or donor plate. In some embodiments, pressure may be applied for, for about, for at least, or for at least about 1 minutes, 2 minutes, 3 minutes, 4 minutes, 5 minutes, 10 minutes, 15 minutes, 20 minutes, 30 minutes, 40 minutes, 50 minutes, 1 hours, 1.5 hours or 2 hours, or any range of values therebetween. In some embodiments, while the release layer and components are contacted for loading the release layer may be heated to a temperature of, of about, of at most, or of at most about, 40° C., 50° C., 60° C., 80° C., 100° C., 110° C., 120° C., 130° C., 140° C. or 150° C., or any range of values therebetween. In some embodiments, the release layer is allowed to cool to room temperature before the pressure is removed. In some embodiments, once the components are attached to the release layer, the carrier substrate may be removed (e.g., peeled off) to afford the component loaded donor plate 110. The component loaded donor plate 110 is then aligned 112 with a target substrate (D) surface prior to irradiation with light source 114 of the release layer (B) through the donor plate (A). Irradiation 118 induces a photochemical reaction in the release layer (B) that catalyzes the decomposition of the material into low molecular weight species that are then vaporized by the heat provided from the irradiation to form components (C) released from the donor plate (A) 120. The vaporization generates a force that pushes the components (C) to land 122 onto the target substrate (D), where they adhere to the surface to form a component loaded substrate 124.

The process illustrated in FIG. 1 depends on the release layer delaminating in the presence of light of specific wavelength and energy (X-ray, UV, vis, IR) and, in the absence of such light, maintaining good adhesion. In various embodiments, the release layer composition is also chemically homogenous, amorphous, and/or optically transparent to facilitate a homogeneous decomposition reaction and homogeneous vapor formation over the area of irradiation.

In some embodiments, the release layer is exposed to radiation of a wavelength of, of about, of at most, or of at most about, 100 nm, 150 nm, 200 nm, 220 nm, 230 nm, 240 nm, 250 nm, 260 nm, 270 nm, 280 nm, 290 nm, 300 nm, 320 nm, 340 nm, 350 nm, 370 nm, 380 nm, 400 nm or 450 nm, or any range of values therebetween for the purpose of activation and/or degradation. In some embodiments, the release layer is heated to a temperature of, of about, of at most, or of at most about, 40° C., 50° C., 60° C., 70° C., 80° C., 90° C., 100° C., 110° C., 120° C., 130° C., 140° C., 150° C., 160° C., 180° C., 200° C., or any range of values therebetween for the purpose of activation and/or degradation.

In some embodiments, the components held and/or transferred by the release layer comprise a longest dimension (e.g., diameter, length, width, thickness) of, of about, of at least, or of at least about, 10 nm, 25 nm, 50 nm, 75 nm, 0.1 μm, 0.2 μm, 0.3 μm, 0.5 μm, 0.8 μm, 0.9 μm, 1 μm, 2 μm, 3 μm, 4 μm, 5 μm, 6 μm, 7 μm, 8 μm, 9 μm, 10μm, 12 μm, 15 μm, 20 μm, 30 μm, 50 μm, 60 μm, 80 μm, 100 μm, 150 μm, 200 μm, 300 μm, 400 μm, 500 μm, 600 μm, 700 μm, 800 μm, 900 μm, 1 mm, 2, mm, 3 mm or 5 mm, or any range of values therebetween.

### Definitions

Unless defined otherwise, all technical and scientific terms used herein have the same meaning as is commonly understood by one of ordinary skill in the art. All patents, applications, published applications and other publications referenced herein are incorporated by reference in their entirety unless stated otherwise. In the event that there are a plurality of definitions for a term herein, those in this section prevail unless stated otherwise.

Whenever a group is described as being “optionally substituted” that group may be unsubstituted or substituted with one or more of the indicated substituents. Likewise, when a group is described as being “unsubstituted or substituted” if substituted, the substituent(s) may be selected from one or more of the indicated substituents. If no substituents are indicated, it is meant that the indicated “optionally substituted” or “substituted” group may be substituted with one or more group(s) individually and independently selected from deuterium (D), halogen, hydroxy, C₁₋₄ alkoxy, C₁₋₈ alkyl, C₃₋₂₀ cycloalkyl, aryl, heteroaryl, heterocyclyl, C₁₋₆ haloalkyl, cyano, C₂₋₈ alkenyl, C₂₋₈ alkynyl, C₃₋₂₀ cycloalkenyl, aryl(alkyl), heteroaryl(alkyl), heterocyclyl(alkyl), acyl, thiocarbonyl, O-carbamyl, N-carbamyl, O-thiocarbamyl, N-thiocarbamyl, C-amido, N-amido, C-thioamido, N-thioamido, S-sulfonamido, N-sulfonamido, C-carboxy, O-carboxy, sulfenyl, sulfinyl, sulfonyl, haloalkoxy, an amino, a mono-substituted amine group and a di-substituted amine group.

As used herein, “Cₐ to C_{b}” in which “a” and “b” are integers refer to the number of carbon atoms in a group. The indicated group can contain from “a” to “b”, inclusive, carbon atoms. Thus, for example, a “C₁ to C₄ alkyl” group refers to all alkyl groups having from 1 to 4 carbons, that is, CH₃—, CH₃CH₂—, CH₃CH₂CH₂—, (CH₃)₂CH—, CH₃CH₂CH₂CH₂—, CH₃CH₂CH(CH₃)— and (CH₃)₃C—. If no “a” and “b” are designated, the broadest range described in these definitions is to be assumed.

As used herein, the term “alkyl” refers to a fully saturated aliphatic hydrocarbon group. The alkyl moiety may be branched or straight chain. Examples of branched alkyl groups include, but are not limited to, iso-propyl, sec-butyl, t-butyl and the like. Examples of straight chain alkyl groups include, but are not limited to, methyl, ethyl, n-propyl, n-butyl, n-pentyl, n-hexyl, n-heptyl and the like. The alkyl group may have 1 to 30 carbon atoms (whenever it appears herein, a numerical range such as “1 to 30” refers to each integer in the given range; e.g., “1 to 30 carbon atoms” means that the alkyl group may consist of 1 carbon atom, 2 carbon atoms, 3 carbon atoms, etc., up to and including 30 carbon atoms, although the present definition also covers the occurrence of the term “alkyl” where no numerical range is designated). The alkyl group may also be a medium alkyl having 1 to 12 carbon atoms. The alkyl group could also be a lower alkyl having 1 to 6 carbon atoms. An alkyl group may be substituted or unsubstituted.

The term “alkenyl” used herein refers to a monovalent straight or branched chain radical of from two to thirty carbon atoms containing a carbon double bond(s) including, but not limited to, 1-propenyl, 2-propenyl, 2-methyl-1-propenyl, 1-butenyl, 2-butenyl and the like. An alkenyl group may be unsubstituted or substituted.

The term “alkynyl” used herein refers to a monovalent straight or branched chain radical of from two to thirty carbon atoms containing a carbon triple bond(s) including, but not limited to, 1-propynyl, 1-butynyl, 2-butynyl and the like. An alkynyl group may be unsubstituted or substituted.

As used herein, the term “hydroxy” refers to a —OH group.

The term “halogen atom” or “halogen” as used herein, means any one of the radio-stable atoms of column 7 of the Periodic Table of the Elements, such as, fluorine, chlorine, bromine and iodine.

Where the numbers of substituents is not specified (e.g. haloalkyl), there may be one or more substituents present. For example, “haloalkyl” may include one or more of the same or different halogens. As another example, “C₁-C₃ alkoxyphenyl” may include one or more of the same or different alkoxy groups containing one, two or three atoms.

As used herein, a radical indicates species with a single, unpaired electron such that the species containing the radical can be covalently bonded to another species. Hence, in this context, a radical is not necessarily a free radical. Rather, a radical indicates a specific portion of a larger molecule. The term “radical” can be used interchangeably with the term “group.”

It is understood that, in any compound described herein having one or more chiral centers, if an absolute stereochemistry is not expressly indicated, then each center may independently be of R-configuration or S-configuration or a mixture thereof. Thus, the compounds provided herein may be enantiomerically pure, enantiomerically enriched, racemic mixture, diastereomerically pure, diastereomerically enriched, or a stereoisomeric mixture. In addition, it is understood that in any compound described herein having one or more double bond(s) generating geometrical isomers that can be defined as E or Z, each double bond may independently be E or Z, or a mixture thereof.

In some embodiments, in any compound described, all tautomeric forms are also intended to be included. For example, without limitation, a reference to the compound

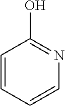

may be interpreted to include tautomer

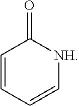

It is to be understood that where compounds disclosed herein have unfilled valencies, then the valencies are to be filled with hydrogens or isotopes thereof, e.g., hydrogen-1 (protium) and hydrogen-2 (deuterium).

It is understood that the compounds described herein can be labeled isotopically. Substitution with isotopes such as deuterium may afford certain therapeutic advantages resulting from greater metabolic stability, such as, for example, increased in vivo half-life or reduced dosage requirements. Each chemical element as represented in a compound structure may include any isotope of said element. For example, in a compound structure a hydrogen atom may be explicitly disclosed or understood to be present in the compound. At any position of the compound that a hydrogen atom may be present, the hydrogen atom can be any isotope of hydrogen, including but not limited to hydrogen-1 (protium) and hydrogen-2 (deuterium). Thus, reference herein to a compound encompasses all potential isotopic forms unless the context clearly dictates otherwise.

Where a range of values is provided, it is understood that the upper and lower limit, and each intervening value between the upper and lower limit of the range is encompassed within the embodiments.

Terms and phrases used in this application, and variations thereof, especially in the appended claims, unless otherwise expressly stated, should be construed as open ended as opposed to limiting. As examples of the foregoing, the term ‘including’ should be read to mean ‘including, without limitation,’ ‘including but not limited to,’ or the like; the term ‘comprising’ as used herein is synonymous with ‘including,’ ‘containing,’ or ‘characterized by,’ and is inclusive or open-ended and does not exclude additional, unrecited elements or method steps; the term ‘having’ should be interpreted as ‘having at least;’ the term ‘includes’ should be interpreted as ‘includes but is not limited to;’ the term ‘example’ is used to provide exemplary instances of the item in discussion, not an exhaustive or limiting list thereof; and use of terms like ‘preferably,’ ‘preferred,’‘desired,’ or ‘desirable,’ and words of similar meaning should not be understood as implying that certain features are critical, essential, or even important to the structure or function, but instead as merely intended to highlight alternative or additional features that may or cannot be utilized in a particular embodiment. In addition, the term “comprising” is to be interpreted synonymously with the phrases “having at least” or “including at least”. When used in the context of a process, the term “comprising” means that the process includes at least the recited steps, but may include additional steps. When used in the context of a compound, composition or device, the term “comprising” means that the compound, composition or device includes at least the recited features or components, but may also include additional features or components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. The indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

### Release Layer, Compositions and Compounds

The composition of the release layer may include an oligomer and/or polymer composition. The oligomer and/or polymer composition may include an oligomeric and/or polymeric component that is a unit containing a tetralin or cyclohexene core and a linkage. For example, in an embodiment, the oligomeric component comprises a unit of the Formula (I) and/or Formula (II).

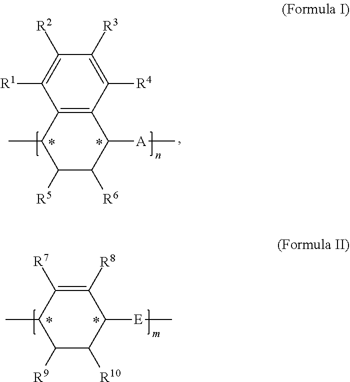

In some embodiments, each * denotes a chiral carbon in the cyclohexyl ring. In some embodiments, a chiral carbon is configured so that the cyclohexene ring is in a cis orientation. In some embodiments, a chiral carbon is configured so that the cyclohexene ring is in a trans orientation. In some embodiments, the polymeric component has a cis:trans ratio of, of about, of at least, of at least about, of at most, or of at most about, 0:100, 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, 95:5 or 100:0, or any range of values therebetween. In some embodiments, n is an integer of 1, 2, 3, 4, 5, 6, 7, 8, 9, 10, 11, 12, 13, 14, 15, 16, 17, 18, 19 or 20, or any range of values therebetween. For example, in some embodiments n is in the range of 1 to 15. In some embodiments, m is an integer of 1, 2, 3, 4, 5, 6, 7, 8, 9, 10, 11, 12, 13, 14, 15, 16, 17, 18, 19 or 20, or any range of values therebetween. For example, in some embodiments m is in the range of 1 to 15. In some embodiments, linkage A is independently —O—, —NH—,

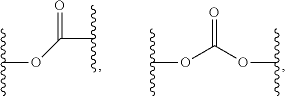 [SMILES: *OC(*)=O ; *OC(=O)O*]

an optionally substituted

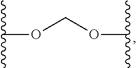 [SMILES: *OCO*]

an optionally substituted

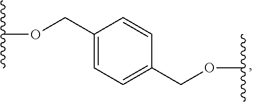 [SMILES: *OCc1ccc(CO*)cc1]

an optionally substituted

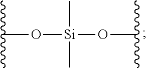 [SMILES: *O[Si](C)(C)O*]

an optionally substituted

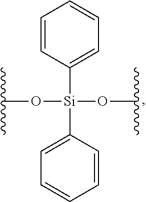 [SMILES: *O[Si](O*)(c1ccccc1)c1ccccc1]

an optionally substituted

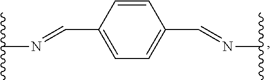 [SMILES: */N=C/c1ccc(/C=N/*)cc1]

an optionally substituted

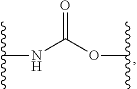 [SMILES: *NC(=O)O*]

an optionally substituted

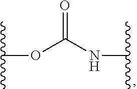 [SMILES: *NC(=O)O*]

an optionally substituted

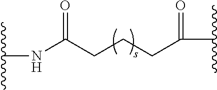

or an optionally substituted

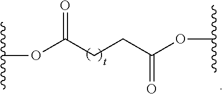 [SMILES: *OC(=O)CCC(=O)O*]

In some embodiments, linkage E is independently —O—, —NH—,

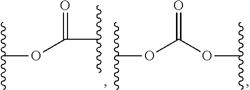

an optionally substituted

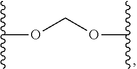 [SMILES: *OCO*]

an optionally substituted

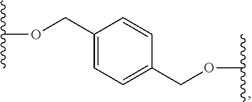 [SMILES: *OCc1ccc(CO*)cc1]

an optionally substituted

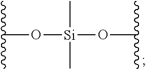 [SMILES: *O[Si](C)(C)O*]

an optionally substituted

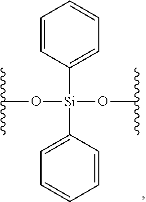 [SMILES: *O[Si](O*)(c1ccccc1)c1ccccc1]

an optionally substituted

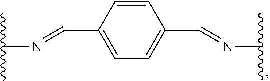 [SMILES: */N=C/c1ccc(/C=N/*)cc1]

an optionally substituted

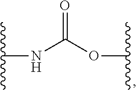 [SMILES: *NC(=O)O*]

an optionally substituted

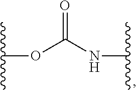 [SMILES: *NC(=O)O*]

an optionally substituted

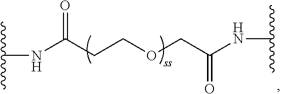

an optionally substituted

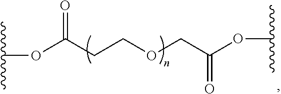

an optionally substituted

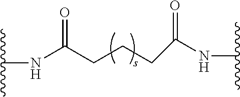

or an optionally substituted

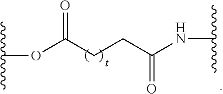 [SMILES: *NC(=O)CCC(=O)O*]

In some embodiments, each R¹ is independently hydrogen, halogen, C₁₋₁₀ alkyl (e.g., C₁₋₃ alkyl), C₂₋₁₀ alkenyl or C₂₋₁₀ alkynyl. In some embodiments, each R² is independently hydrogen, halogen, C₁₋₁₀ alkyl (e.g., C₁₋₃ alkyl), C₂₋₁₀ alkenyl or C₂₋₁₀ alkynyl. In some embodiments, each R³ is independently hydrogen, halogen, C₁₋₁₀ alkyl (e.g., C₁₋₃ alkyl), C₂₋₁₀ alkenyl or C₂₋₁₀ alkynyl. In some embodiments, each R⁴ is independently hydrogen, halogen, C₁₋₁₀ alkyl (e.g., C₁₋₃ alkyl), C₂₋₁₀ alkenyl or C₂₋₁₀ alkynyl. In some embodiments, each R⁵ is independently hydrogen, halogen, C₁₋₁₀ alkyl (e.g., C₁₋₃ alkyl), C₂₋₁₀ alkenyl or C₂₋₁₀ alkynyl. In some embodiments, each R⁶ is independently hydrogen, halogen, C₁₋₁₀ alkyl (e.g., C₁₋₃ alkyl), C₂₋₁₀ alkenyl or C₂₋₁₀ alkynyl. In some embodiments, each R⁷ is independently hydrogen, halogen, C₁₋₁₀ alkyl (e.g., C₁₋₃ alkyl), C₂₋₁₀ alkenyl or C₂₋₁₀ alkynyl. In some embodiments, each R⁸ is independently hydrogen, halogen, C₁₋₁₀ alkyl (e.g., C₁₋₃ alkyl), C₂₋₁₀ alkenyl or C₂₋₁₀ alkynyl. In some embodiments, each R⁹ is independently hydrogen, halogen, C₁₋₁₀ alkyl (e.g., C₁₋₃ alkyl), C₂₋₁₀ alkenyl or C₁₋₁₀ alkynyl. In some embodiments, each R¹⁰ is independently hydrogen, halogen, C₁₋₁₀ alkyl (e.g., C₁₋₃ alkyl), C₂₋₁₀ alkenyl or C₂₋₁₀ alkynyl. In some embodiments, each s is independently an integer in the range of 1 to 10. In some embodiments, each t is independently an integer in the range of 1 to 10. In some embodiments, each ss is independently an integer in the range of 1 to 10. In some embodiments, each tt is independently an integer in the range of 1 to 10. In some embodiments, each s is independently an integer in the range of 1 to 10. In some embodiments, each t is independently an integer in the range of 1 to 10.

In some embodiments, the release layer composition comprises a polymer material. In some embodiments, the release layer composition comprises a polymeric component that is intermixed with the oligomeric component. In some embodiments, the polymeric component forms a homogenous film with the oligomeric component. In some embodiments, the polymer component comprises a plurality of polymers. In some embodiments, polymeric component can be used in amounts effective to modulate material properties and/or the release properties of the release layer film. In some embodiments, polymeric components include a linear homopolymer, block copolymer, polymeric network, etc. In some embodiments, the polymeric component acts as a matrix to support the oligomeric component, dictates the release layer's physical properties and/or optical properties. Tailoring the material properties of the release layer by modifying the polymeric component may be advantageous as the properties of the release layer can be altered on a per application basis without having to redesign the oligomeric ingredient. Furthermore, different polymers can alter the processing conditions for adhering the components to the release layer. In addition, network polymers may aid to trap non-volatile residue from being transferred during gas evolution. In some embodiments, the polymeric component is photochemically inert. In some embodiments, the polymeric component is photochemically active. Examples of potential polymeric components include: a polymeric component containing a tetralin or cyclohexene core and a linkage, polypropylene, poly(propyl carbonate), polyurethane, ABS block copolymer, polyesters, polyvinyl chloride, polystyrene, copolymers thereof, and combinations thereof. An example of a network polymer could be a polyethylene glycol polymer crosslinked by thiol-ene photochemistry after deposition onto the donor substrate. As another example, in an embodiment, the polymeric component comprises a unit of the Formula (III) and/or Formula (IV).

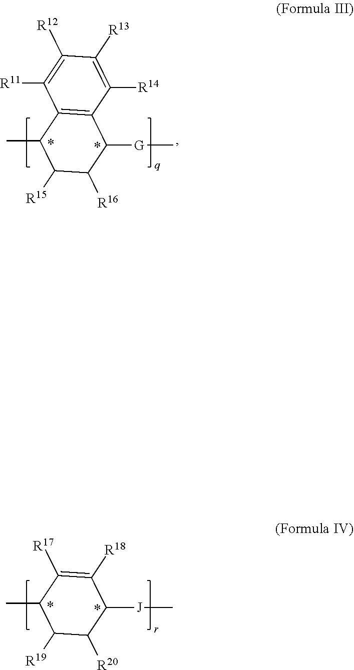

In some embodiments, each * of the Formula (III) and/or Formula (IV) denotes a chiral carbon in the cyclohexene ring. In some embodiments, a chiral carbon is configured so that the cyclohexene ring is in a cis orientation. In some embodiments, a chiral carbon is configured so that the cyclohexyl ring is in a trans orientation. In some embodiments, the polymeric component has a cis:trans ratio of, of about, of at least, of at least about, of at most, or of at most about, 0:100, 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, 95:5 or 100:0, or any range of values therebetween. In some embodiments, q is an integer of 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 55, 60, 65, 70, 75, 80, 85, 90, 95, 100, 120, 150, 200, 300, 400, 500, 600, 800 or 1000, or any range of values therebetween. For example, in some embodiments q is in the range of 16-50 or 16-200. In some embodiments, r is an integer of 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 55, 60, 65, 70, 75, 80, 85, 90, 95, 100, 120, 150, 200, 300, 400, 500, 600, 800 or 1000, or any range of values therebetween. For example, in some embodiments r is in the range of 16-50 or 16-200. In some embodiments, linkage G is independently —O—, —NH—,

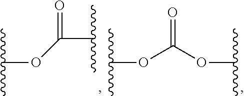

an optionally substituted

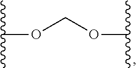 [SMILES: *OCO*]

an optionally substituted

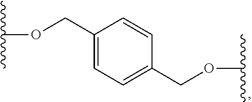 [SMILES: *OCc1ccc(CO*)cc1]

an optionally substituted

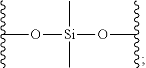 [SMILES: *O[Si](C)(C)O*]

an optionally substituted

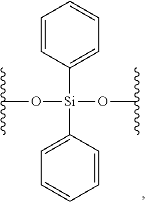 [SMILES: *O[Si](O*)(c1ccccc1)c1ccccc1]

an optionally substituted

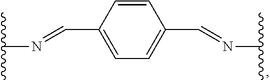 [SMILES: */N=C/c1ccc(/C=N/*)cc1]

an optionally substituted

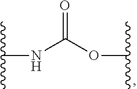 [SMILES: *NC(=O)N*]

an optionally substituted

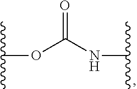 [SMILES: *NC(=O)O*]

an optionally substituted

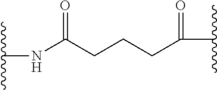 [SMILES: *NC(=O)CCCC(*)=O]

or an optionally substituted

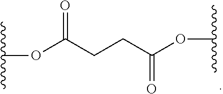 [SMILES: *OC(=O)CCC(=O)O*]

In some embodiments, linkage J is independently —O—, —NH—,

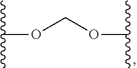 [SMILES: *OCO*]

an optionally substituted

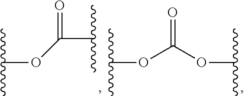

an optionally substituted

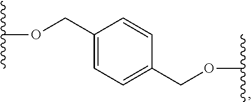 [SMILES: *OCc1ccc(CO*)cc1]

an optionally substituted

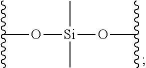 [SMILES: *O[Si](C)(C)O*]

an optionally substituted

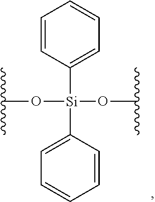 [SMILES: *O[Si](O*)(c1ccccc1)c1ccccc1]

an optionally substituted

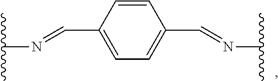 [SMILES: */N=C/c1ccc(/C=N/*)cc1]

an optionally substituted

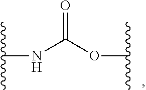 [SMILES: *NC(=O)O*]

an optionally substituted

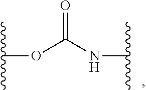 [SMILES: *NC(=O)O*]

an optionally substituted

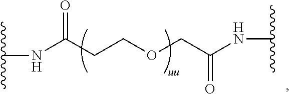

an optionally substituted

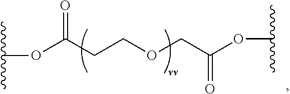

an optionally substituted

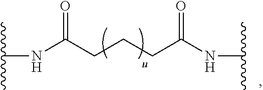

or an optionally substituted

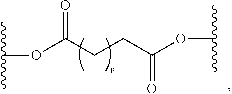

In some embodiments, each R¹¹ is independently hydrogen, halogen, C₁₋₁₀ alkyl (e.g., C₁₋₃ alkyl), C₂₋₁₀ alkenyl or C₂₋₁₀ alkynyl. In some embodiments, each R¹² is independently hydrogen, halogen, C₁₋₁₀ alkyl (e.g., C₁₋₃ alkyl), C₂₋₁₀ alkenyl or C₂₋₁₀ alkynyl. In some embodiments, each R¹³ is independently hydrogen, halogen, C₁₋₁₀ alkyl (e.g., C₁₋₃ alkyl), C₂₋₁₀ alkenyl or C₂₋₁₀ alkynyl. In some embodiments, each R¹⁴ is independently hydrogen, halogen, C₁₋₁₀ alkyl (e.g., C₁₋₃ alkyl), C₂₋₁₀ alkenyl or C₂₋₁₀ alkynyl. In some embodiments, each R¹⁵ is independently hydrogen, halogen, C₁₋₁₀ alkyl (e.g., C₁₋₃ alkyl), C2-10 alkenyl or C₂₋₁₀ alkynyl. In some embodiments, each R¹⁶ is independently hydrogen, halogen, C₁₋₁₀ alkyl (e.g., C₁₋₃ alkyl), C₂₋₁₀ alkenyl or C₂₋₁₀ alkynyl. In some embodiments, each R¹⁷ is independently hydrogen, halogen, C₁₋₁₀ alkyl (e.g., C₁₋₃ alkyl), C₂₋₁₀ alkenyl or C₂₋₁₀ alkynyl. In some embodiments, each R¹⁸ is independently hydrogen, halogen, C₁₋₁₀ alkyl (e.g., C₁₋₃ alkyl), C₂₋₁₀ alkenyl or C₂₋₁₀ alkynyl. In some embodiments, each R¹⁹ is independently hydrogen, halogen, C₁₋₁₀ alkyl (e.g., C₁₋₃ alkyl), C₂₋₁₀ alkenyl or C₂₋₁₀ alkynyl. In some embodiments, each R²⁰ is independently hydrogen, halogen, C₁₋₁₀ alkyl (e.g., C₁₋₃ alkyl), C₂₋₁₀ alkenyl or C₂₋₁₀ alkynyl. In some embodiments, each uu is independently an integer in the range of 1 to 10. In some embodiments, each vv is independently an integer in the range of 1 to 10. In some embodiments, each u is independently an integer in the range of 1 to 10. In some embodiments, each v is independently an integer in the range of 1 to 10.

When irradiated the linkages (e.g., linkages A, E, G and/or J) are cleaved either through heat alone, generated by photothermal heating, or through heat and nucleophilic, acid and/or base catalyzation. Upon cleavage of the linkages, the residue of the linkage is converted into a relatively volatile, unreactive small molecule. The gaseous byproducts generate a force through volume expansion that pushes the adhered component onto the target substrate. The tetralin core is an aromatic chromophore that facilitates film heating with irradiation (e.g., by a laser) with a wavelength approximately in the range of 240-300 nm. The cyclohexene core may be indirectly heated through irradiation of a compound within the film that acts as a chromophore. The ability to undergo effective heating drives the decomposition kinetics to a microsecond timescale that facilitates a homogenous transfer force.

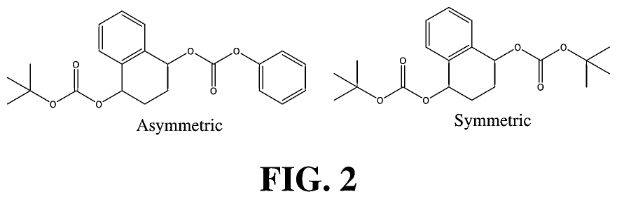

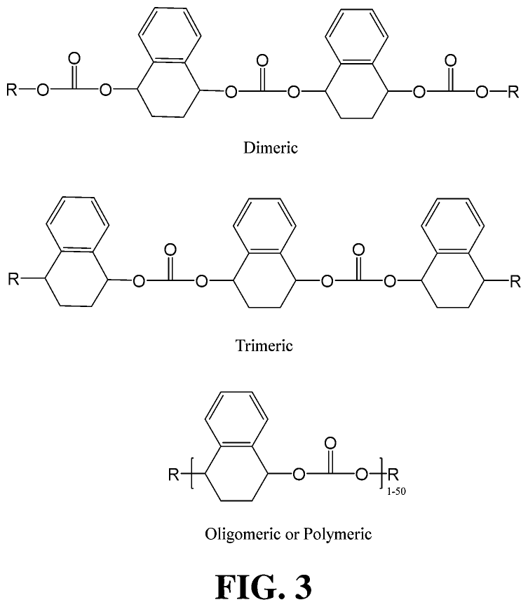

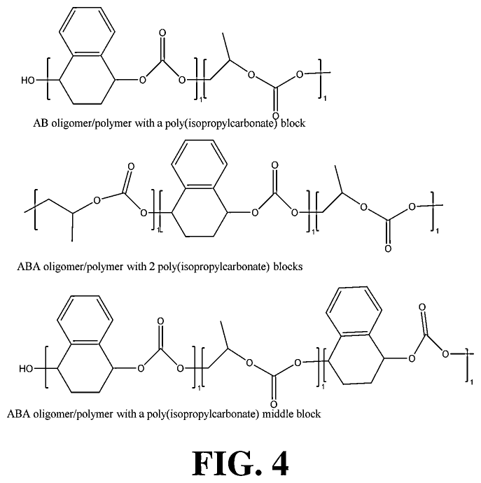

The efficiency of the process illustrated in FIG. 1 depends on the core structure of the oligomeric component and/or the polymeric component (for embodiments in which the polymeric component contains a photochemically active component). In some embodiments, the oligomeric or polymeric component includes a unit of the tetralin (i.e. bicyclic tetrahydronaphthalene) or cyclohexene core that is connected to a carbonate linkage. The structures can be monomeric as in the examples shown in FIG. 2, or dimeric, trimeric, oligomeric, or polymeric as shown in FIG. 3, as long as the component contains the cores and linkages described herein. FIG. 4 shows examples of oligomeric or polymeric component as diblock, triblock, or multiblock block co-oligomers/polymers.

In various embodiments, the aromatic portion of the tetralin (i.e. tetrahydronapthalene) or another compound serve as a chromophore for UV-irradiation that will serve to convert light into heat for decomposition and vaporization of decomposition products and/or volatile additives. In some embodiments the decomposed cores may be converted into unreactive and volatile products. For example, for carbonate linkages attached to benzylic positions of tetralin (i.e. tetrahydronapthalene), when the carbonates are cleaved the tetrahydronaphthalene core will be converted into naphthalene, which is unreactive and volatile. This also drives the decomposition reaction to completion due to formation of an aromatic system. As another example, benzylic carbonates (e.g. oligomeric or polymeric components with a tetralin (i.e. tetrahydronapthalene) unit and a carbonate linkage) may be advantageous as the benzylic functionality stabilizes the cationic intermediate of carbonate cleavage and may result in a much faster and lower energy cleavage reaction. As a further example, bis-carbonate core (i.e. oligomeric or polymeric components with a tetralin (i.e. tetrahydronapthalene) or cyclohexene linked to two carbonate linkages) may be advantageous as cleaving two carbonates results in the formation of two C═C bonds thereby resulting in a fully aromatic structure. The formation of the aromatic structure may aid in driving the rapid linkage cleavage and gas formation.

Examples of cores and linkages for oligomeric and polymeric components are illustrated below in Table 1.

TABLE 1

| Linkage | Tetralin Core | Cyclohexene Core |
|---|---|---|
| Carbonate | 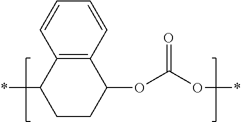 | 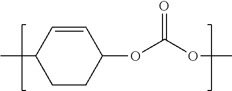 |
| Ether | 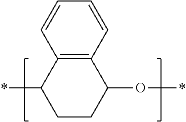 | 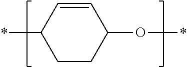 |
| Ketal | 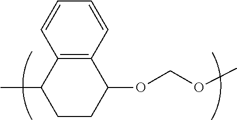 | 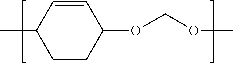 |
| O-type Carbamate | 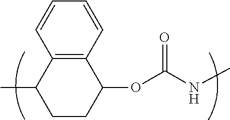 | 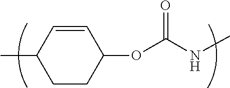 |
| N-type Carbamate | 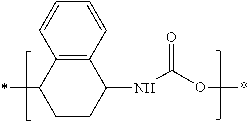 | 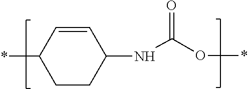 |
| O-type and N- type Carbamate | 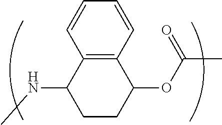 | 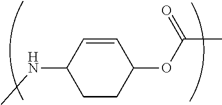 |
| Amide | 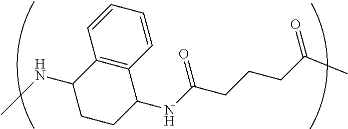 | 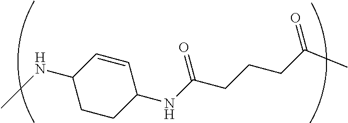 |
| O-type Ester | 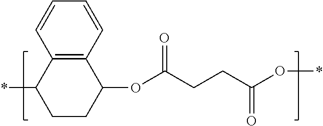 | 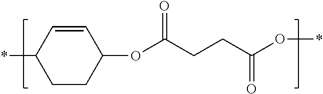 |
| O-type Ether | 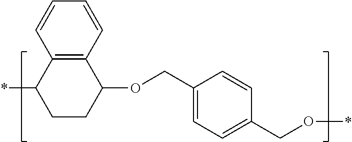 | 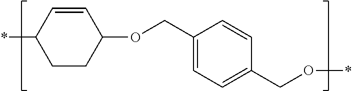 |
| N-type Enamine | 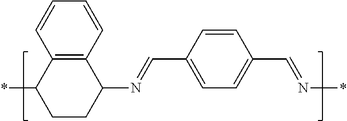 | 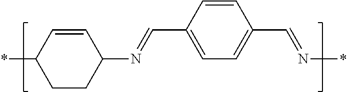 |
| O-type Diphenyl Silyl Ether | 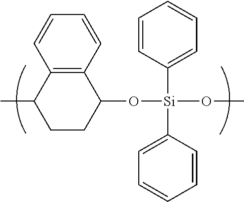 | 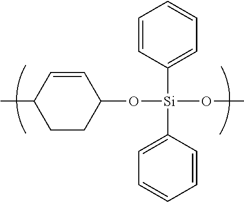 |
| O-type Silyl Ether | 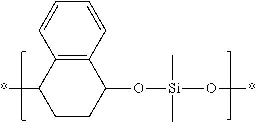 | 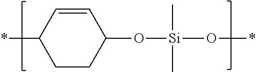 |

In some embodiments, the polymeric and/or oligomeric component has a number averaged molecular weight (Mn) of, of about, of at least, or of at least about, 1000 g/mol, 1500 g/mol, 1800 g/mol, 1900 g/mol, 2000 g/mol, 2100 g/mol, 2200 g/mol, 2300 g/mol, 2400 g/mol, 2600 g/mol, 2800 g/mol, 3000 g/mol, 3250 g/mol, 3500 g/mol, 3750 g/mol, 4000 g/mol, 4250 g/mol, 4500 g/mol, 5000 g/mol, 6000 g/mol, 7000 g/mol, 8000 g/mol, 10000 g/mol, 15000 g/mol, 20000 g/mol, 25000 g/mol, 50000 g/mol, 100000 g/mol, 150000 g/mol, 200000 g/mol, 250000 g/mol, 500000 g/mol, 1000000 g/mol or 1500000 g/mol, or any range of values therebetween. In some embodiments, the polymeric and/or oligomeric component has a weight averaged molecular weight (Mw) of, of about, of at least, or of at least about, 2000 g/mol, 2100 g/mol, 2200 g/mol, 2300 g/mol, 2400 g/mol, 2600 g/mol, 2800 g/mol, 3000 g/mol, 3250 g/mol, 3500 g/mol, 3750 g/mol, 4000 g/mol, 4250 g/mol, 4500 g/mol, 5000 g/mol, 5500 g/mol, 6000 g/mol, 6500 g/mol, 7000 g/mol, 8000 g/mol, 10000 g/mol, 15000 g/mol, 20000 g/mol, 25000 g/mol, 50000 g/mol, 100000 g/mol, 150000 g/mol, 200000 g/mol, 250000 g/mol, 500000 g/mol, 1000000 g/mol, 1500000 g/mol or 2000000 g/mol, or any range of values therebetween. In some embodiments, the polymeric and/or oligomeric component has a Mw:Mn ratio of, of about, of at least, or of at least about 1:1, 1.1:1, 1.2:1, 1.3:1, 1.4:1, 1.5:1, 1.6:1, 1.75:1, 2:1, 2.25:1, 2.5:1, 3:1, or 4:1, or any range of values therebetween.

In some embodiments, the polymeric and/or oligomeric component has a glass transition temperature (T_{g}) of, of about, of at most, of at most about, of at least, or of at least about, 200° C., 160° C., 150° C., 145° C., 140° C., 135° C., 130° C., 125° C., 120° C., 115° C., 110° C., 105° C., 100° C., 90° C., 80° C., 75° C., 60° C., 50° C., 45° C., 40° C., 35° C., 30° C., 25° C., 20° C., 15° C., 10° C., 5° C., 0° C., −5° C., −10° C., −15° C., −20° C., −25° C., −30° C., −35° C., −40° C., −45° C., −50° C. or −60° C., or any range of values therebetween.

In some embodiments, the formulation comprises cis isomers of the polymeric and/or oligomeric component. In some embodiments, the formulation comprises trans isomers of the polymeric and/or oligomeric component. In some embodiments, the formulation comprises both cis and trans isomers of the polymeric and/or oligomeric component. In some embodiments, a mixture of the cis and trans isomers reduces or prevents crystallization of the polymeric and/or oligomeric component.

In embodiments of the release layer compositions described herein, the decomposing material (e.g. the oligomeric component) is a majority ingredient (i.e. the ingredient that makes up the largest wt% or mass%) of the release layer formulation. In embodiments of the release layer compositions described herein, the decomposing material (e.g. the oligomeric component) is a minority ingredient of the release layer formulation. For example, in an embodiment, a polymeric component can be the main ingredient of the release layer, while the oligomeric component is a minority ingredient. In some embodiments, the release layer composition comprises, comprises about, comprises at least, comprises at least about, comprises at most, or comprises at most about, 1 wt. %, 5 wt. %, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, 95 wt. % or 98 wt. % of the oligomeric component, or any range of values therebetween. In some embodiments, the release layer composition comprises, comprises about, comprises at least, comprises at least about, comprises at most, or comprises at most about, 1 wt. %, 5 wt. %, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, 95 wt. % or 98 wt. % of the polymeric component, or any range of values therebetween.

In various embodiments, the release layer composition comprises an (optional) thermal sensitizing agent, in the form of one or more additives that absorb light and convert it into heat. Thermal sensitizing agents may have a high photon absorption quantum yield, a low fluorescence/phosphorescence quantum yield, and/or a short excited state lifetimes that decay through non-irradiative pathways. They may be used in amounts effective to aid the heating rate during irradiation and thereby increase the rate of linkage decomposition and gas formation. These agents can also facilitate heating with lower power and longer wavelength lasers. In some embodiments, the thermal sensitizing agent will form a homogenous film with the release layer formulation. In some embodiments, the thermal sensitizing agent will form a transparent film with the release layer formulation. In some embodiments, the thermal sensitizing agent will form an opaque film with the release layer formulation. Examples of thermal sensitizing agents in some embodiments include, inorganic agents, gold plasmonic nanoparticles, silver plasmonic nanoparticles, gold nanowires, silver nanowires, carbon based agents, carbon nanotubes, carbon black, graphene, graphene oxide, organic based agents, and metallic agents. In some embodiments, organic based thermal sensitizing agents include one or more of the following structural properties: aromaticity, fused multicyclic systems, S or N containing heterocycles, multicyclic systems, and/or multi-aromatic systems. Examples of organic based thermal sensitizing agents include melanin, eumelanin, indole, pyrrole, quinoline, purine, triphenyl methyl compounds (e.g. (methoxymethanetriyl)tribenzene), fused aromatic compounds (e.g. anthracene and pyrene), dibenzothiophene, thiophene, and derivatives thereof.

In various embodiments, an (optional) acid or base additive is included in the release layer composition in an amount effective to catalyze the oligomeric and/or polymeric decomposition. In some embodiments, the acid additive is selected from a sulfonic acid (e.g., p-toluenesulfonic acid, methane sulfonic acid, heptadecafluorooctanesulfonic acid), a benzoic acid (e.g., benzoic acid, salicylic acid, nonyloxybenzoic acid, oxybis(benzoic acid)), a monocarboxylic acid (e.g., butyric acid, perfluorooctanoic acid), a multifunctional carboxylic acid (e.g., citric acid, malic acid, fumaric acid), derivatives thereof (e.g., butene-1,2-dio-1(p-toluenesulfonate)), and combinations thereof. In some embodiments, the base additive is selected from an ammonium hydroxide (e.g., Tetrabutylammonium hydroxide), a tertiary amine (e.g., N,N-diisopropylethylamine), an amino base (e.g., 1,4-diazabicyclo[2.2.2]octane, Bis [2-(N,N-dimethylamino)ethyl] ether, Pentamethyldiethylenetriamine, 1,8-Diazabicyclo[5.4.0]undec-7-ene, 1,5,7-triazabicylco[4.4.0]dec-5-ene), a pyridine base (e.g., 4-(Dimethylamino)pyridine), derivatives thereof, and combinations thereof. In some embodiments, the acid additive is a photoacid generator (PAG). In some embodiments, the PAG includes a chromophore unit and an acid precursor unit. In some embodiments, the chromophore unit is selected from diphenyliodonium, triphenylsulfonium, and combinations thereof. In some embodiments, the acid precursor unit is selected from trifluoromethanesulfonate (i.e., triflate), hexafluorophosphate, nitrate, p-toluenesulfonate, perfluoro-1-butanesulfonate, and combinations thereof. In some embodiments, the PAG is an ionic PAG or a non-ionic PAG. In some embodiments, the ionic PAG is selected from diphenyliodonium nitrate, bis(4-tert-butylphenyl) iodonium perfluoro-1-butanesulfonate, bis(4-tert-butylphenyl)iodonium p-toluenesulfonate, (4-phenylthiophenyl)diphenylsulfonium triflate, triarylsulfonium hexafluorophosphate, and combinations thereof. In some embodiments, the non-ionic PAG is selected from N-hydroxynaphthalimide triflate, N-hydroxy-5-norbornene-2,3-dicarboximide perfluoro-1-butanesulfonate, 2-(4-methoxystyryl)-4,6,-bis(trichloromethyl)-1,3,5-tirazine, and combinations thereof. In some embodiments, the PAG is (4-Phenylthiophenyl)diphenylsulfonium trifluoromethanesulfonate. In some embodiments, the acid or base additive is included in the release layer composition in an amount of, of about, of at most, or of at most about, 0.1 wt %, 0.5 wt %, 1 wt %, 2 wt %, 3 wt %, 5 wt %, 8 wt %, 10 wt %, 12 wt %, 15 wt %, 18 wt % or 20 wt %, or any range of values therebetween.

In various embodiments, the release layer composition comprises an (optional) low molecular weight additives that will vaporize under the conditions of the transfer. One or more such additives can be used in amounts that are effective to enhance the force generation during irradiation and thereby may aid in the lift or release of components from the release layer. In some embodiments, a low molecular weight additive may also aid in altering the viscoelastic properties of the release layer, thereby facilitating faster bonding at lower temperatures.

In another embodiment, additives that absorb light and convert it into heat can be the main ingredient of the release layer. They may be used in amounts effective to aid the heating rate during irradiation and thereby increase the rate of oligomeric and/or polymeric decomposition and gas formation. These agents can also facilitate heating with lower power and longer wavelength lasers. Examples of additives include collodial metals, Si, SiO₂, TiO₂, SnO₂, anthracene, naphthalene, dimethoxybenzene, tetrahydronaphthalene, diphenyl ether, phenylcyclohexane, tert-butylphenol, acetoxy-tetrahydronaphthalene, and derivatives thereof. In some embodiments, the additives are configured to absorb at wavelengths of, of about, of at most, of at most about, of at least, or of at least about, 300 nm, 320 nm, 350 nm, 400 nm, 450 nm, 500 nm, 550 nm, 600 nm, 650 nm, 700 nm, 750 nm, 800 nm, 850 nm, 900 nm, 950 nm, 1000 nm, 1100 nm, 1300 nm or 1500 nm, or any range of values therebetween.

In another embodiment, additives that vaporize under the conditions of the transfer can be the main ingredient of the release layer. Additives may be used in amounts effective to enhance the force generation during irradiation. In some embodiments, the additive may be any organic molecule that does not contain heteroatoms besides oxygen. The additives may be used to modulate the physical properties for processing the release layer in its solid film state by lowering the films Tg, which may allow for reduced temperatures and pressures to be utilized while attaching components to be transferred. In some embodiments, additives are vaporizable when irradiated.

In some embodiments, the additive has a molecular weight of, of about, of at most, or of at most about, 500 Da, 300 Da, 200 Da, 180 Da, 160 Da, 150 Da, 140 Da, 130 Da, 120 Da, 110 Da, 100 Da, 80 Da, 50 Da, 30 Da or 10 Da, or any range of values therebetween. In some embodiments, the additive has a boiling point of, of about, of at most, or of at most about, 400° C., 300° C., 275° C., 250° C., 200° C., 190° C., 180° C., 170° C., 160° C., 150° C., 140° C., 130° C., 120° C., 110° C., 100° C., 90° C., 80° C., 70° C., 60° C., 50° C. or 40° C., or any range of values therebetween. In some embodiments, the additive has a flash point of, of about, of at least, or of at least about, 800° C., 700° C., 600° C., 550° C., 500° C., 475° C., 450 ° C., 425° C., 400° C., 375° C., 350° C., 320° C., 310° C., 300° C., 275° C., 250° C. or 200° C., or any range of values therebetween. In some embodiments, the additive has a melting point of, of about, of at most, or of at most about, 250° C., 200° C., 150° C., 140° C., 130° C., 120° C., 110 ° C., 100° C., 90° C., 80° C., 70° C., 60° C., 50° C., 40° C., 35° C., 30° C., 25° C., 20° C., 10° C. or 0° C., or any range of values therebetween. In some embodiments, the additive has a room temperature vapor pressure of, of about, of at most, or of at most about, 0.8 torr, 0.7, tore, 0.6 torr, 0.5 torr, 0.4 torr, 0.3 torr, 0.2 torr, 0.1 torr, 0.08 torr, 0.06 torr, 0.04 torr, 0.02 torr or 0.01 torr, or any range of values therebetween.

In some embodiments, the oligomer and/or polymer composition comprises a plurality of oligomeric and/or polymeric components. In some embodiments, at least two oligomeric and/or polymeric components are different components. In some embodiments, the release layer comprises a plurality of release layer sublayers. In some embodiments, the release layer has a thickness of, of about, of at most, or of at most about, 0.1 μm, 0.5 μm, 0.8 μm, 0.9 μm, 1 μm, 1.1 μm, 1.2 μm, 1.3 μm, 1.4 μm, 1.5 μm, 1.6 μm, 1.8 μm, 2 μm, 2.2 μm, 2.5 μm, 3 μm, 3.5 μm or 4 μm, 5 μm, 7 μm, 10 μm, 15 μm, 20 μm, 25 μm, 30 μm, 40 μm, 50 μm, 60 μm, 70 μm, 80 μm, 90 μm, 100 μm, 120 μm, 150 μm or 200 μm, or any range of values therebetween.

### EXAMPLES

The syntheses of oligomeric components and intermediates are described in the Examples below. Examples 12-14 describe release layer formulations and depositions.

¹H NMR analysis was performed with a 500 MHz Bruker Avance Neo instrument.

### Example 1

Scheme 1 shows the one step synthesis of (A) 1,1′-(1,2,3,4-Tetrahydro-1,4-naphthalenediyl) di-1H-imidazole-1-carboxylate.

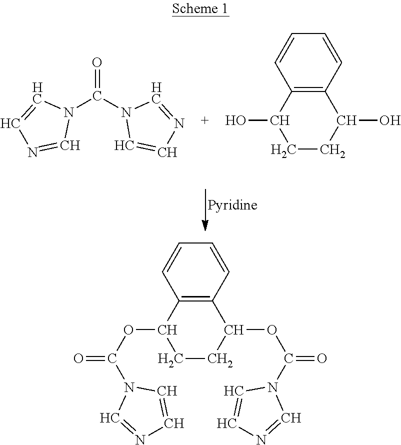 [SMILES: O=C(n1ccnc1)n1ccnc1 ; OC1CCC(O)c2ccccc21 ; O=C(OC1CCC(OC(=O)n2ccnc2)c2ccccc21)n1ccnc1]

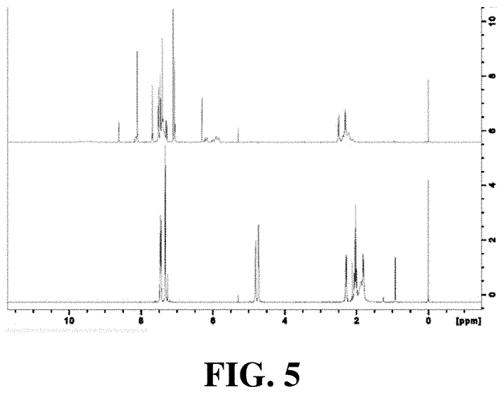

(A) 1,1′-(1,2,3,4-Tetrahydro-1,4-naphthalenediyl) di-1H-imidazole-1-carboxylate: A solution of 1,1′-carbonyldiimidazole (34.5 g, 212.8 mmol) in dichloromethane (265 mL) was added dropwise via a dropping funnel to a solution of 1,4-dihydroxy-1,2,3,4-tetrahydronaphthalene (17.4 g, 106.3 mmol) in pyridine (15.8 mL, 195.7 mmol) and dichloromethane (160 mL) in a 1 L round-bottom flask. The mixture was stirred gently at room temperature for 16 h. At this point more dichloromethane (265 ml) was added, and the mixture was stirred another 6 h. It was then quenched with deionized water (160 mL). The reaction mixture was transferred to a separatory funnel and the lower organic phase was removed. The aqueous phase was extracted with dichloromethane (200 mL×2) and all the dichloromethane extracts were combined. The solution was washed with deionized water (150 mL×2), a 1.0% solution of acetic acid (150 mL×3), again with deionized water (150 mL×3), dried over anhydrous MgSO₄, and filtered. The solvent was then removed on a rotary evaporator. The crude product was dried under vacuum overnight at room temperature, yielding a beige solid (31.6 g, 84%). Yield based on 1,4-dihydroxy-1,2,3,4-tetrahydronaphthalene. δH (300 MHz, CDCl₃): 8.16, 8.08 (2×2 H, s, CH im), 7.49-7.37 (12 H, br.m, CH im and CH Ar), 7.07, 7.04 (2×2 H, s, CH im), 6.28, 6.18 (2×2 H, m, CH—O), 2.49-2.26 (8 H, br.m, CH2-CH2). FIG. 5 depicts the H-NMR spectra of 1,1′-(1,2,3,4-Tetrahydro-1,4-naphthalenediyl) di-1H-imidazole-1-carboxylate (top) and its 1,4-dihydroxy-1,2,3,4- tetrahydronaphthalene precursor (bottom).

### Example 2

Scheme 2 shows the one step synthesis of (B) 1,1′-(1,2,3,4-Tetrahydro-1,4-naphthalenediyl) di-tert-butyl carbonate.

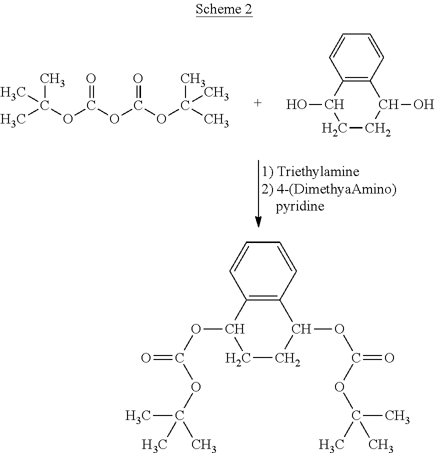 [SMILES: CC(C)(C)OC(=O)OC(=O)OC(C)(C)C ; OC1CCC(O)c2ccccc21 ; CC(C)(C)OC(=O)OC1CCC(OC(=O)OC(C)(C)C)c2ccccc21]

(B) 1,1′-(1,2,3,4-Tetrahydro-1,4-naphthalenediyl) di-tert-butyl carbonate: To a solution of triethylamine (0.263 ml, 1.87 mmol) and 4-(dimethylamino)pyridine (5.2 mg, 0.043 mmol) in dry dichloromethane (5 ml), 1,4-dihydroxy-1,2,3,4-tetrahydronaphthalene (140 mg, 0.852 mmol) is added and the clear solution is allowed to stir for 15 min. Di-tert-butyl dicarbonate (560 mg, 2.56 mmol) is added, and the solution is allowed to stir for a further 2 h, in which time it develops a light clear yellow color. The product is extracted from ethyl acetate and is washed with 3 brine and dried over MgSO4. Further purification is performed using silica gel chromatography (EtOAc:n-hexane, 1:4). The solvent is removed And the product is isolated.

### Example 3

Scheme 3 shows the two step synthesis of (C) 1-(1-Imidazolylcarbonyloxy)-1,2,3,4-tetrahydronaphthalene and (D) 1,1′-(1,2,3,4-Tetrahydro-1,4-naphthalenediyl) di-1-(1,2,3,4-tetrahydro-1,4-napthalenediyl) carbonate.

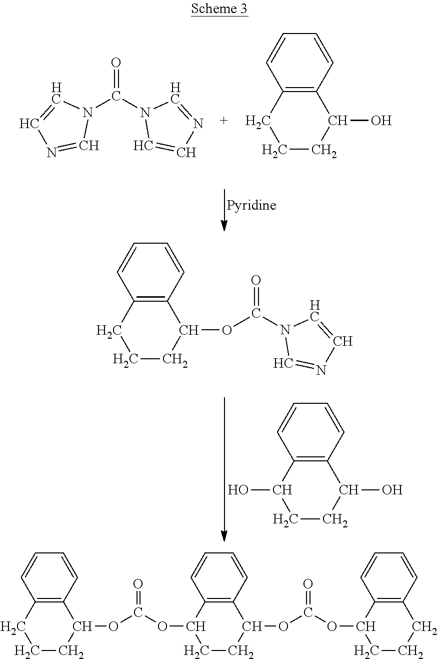

(C) 1-(1-Imidazolylcarbonyloxy)-1,2,3,4-tetrahydronaphthalene: Carbonyl-N,N′-diimidazole (1.46 g, 9.0 mmol) is added slowly to a solution of 1.0 g (6.7 mmol) 1,2,3,4-tetrahydronaphthalen-1-ol in 8 ml of chloroform. Heat is generated from the highly exothermic reaction, which is completed after stirring for 30 min. The reaction solution is extracted twice with 10 ml of water. The organic phase is dried over Na₂SO₄. The solvent is removed under reduced pressure and the crude product is purified by crystallization from n-hexane/ethyl acetate.

(D) 1,1′-(1,2,3,4-Tetrahydro-1,4-naphthalenediyl) di-1-(1,2,3,4-tetrahydro-1,4-napthalenediyl) carbonate: In an ampule with a PTFE stopcock, 1,4-dihydoxy-1,2,3,4-tetrahydronaphthalene (12.9 g, 78.6 mmol), (C) 1-(1-Imidazolylcarbonyloxy)-1,2,3,4-tetrahydronaphthalene (3,880 g, 160.0 mmol), 18-crown-6 (4.3 g, 16.0 mmol) and anhydrous potassium carbonate anhydrous (56.9 g, 412 mmol) are combined. This ampule is connected to a high vacuum pump and the materials engaged are further dried for 24 h. Dry CH2Cl2 (430 mL) is added. The sealed ampule is stirred magnetically and heated in an oil bath at 45° C. for 5 days under nitrogen. At the end of the reaction, more CH2Cl2 (250 mL) and a saturated solution of sodium bicarbonate (250 mL) are added to the ampule. The reaction mixture is transferred to a separatory funnel and the lower organic phase is removed. The aqueous phase is extracted with CH2Cl2 (200 mL×2) and the CH2Cl2 extracts are combined. The dichloromethane solution is then washed with deionized water (150 mL×2), a saturated solution of sodium bicarbonate (150 mL×3), again with deionized water (150 mL×3), and dried over anhydrous MgSO4. After filtration, the solution is concentrated on a rotary evaporator and the polymer is precipitated in methanol (600 mL). The polymer is recovered as a beige powder by filtration and washed with MeOH (100 mL), collected and dried under vacuum for 24 h at room temperature.

### Example 4

Scheme 4 shows the one step synthesis of (E) 1,4-di-tert-butoxy-1,2,3,4-tetrahydronaphthalene.

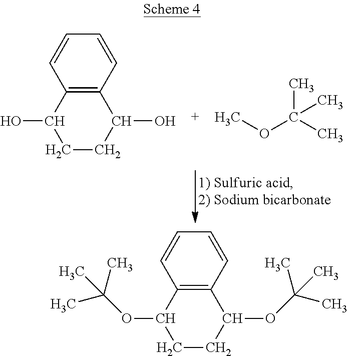

(E) 1,4-di-tert-butoxy-1,2,3,4-tetrahydronaphthalene: Sulfuric acid (20 mmol) is added very slowly to a stirring solution of 1,4-dihydoxy-1,2,3,4-tetrahydronaphthalene (1.6 g ,10 mmol), 2 g of molecular sieves, and 20 ml of methyl tert-butyl ether in round-bottom flask. The reaction is stirred for 7 hours at room temperature and then slowly quenched over the period of 2 hours by the addition of 20 ml of saturated aqueous sodium bicarbonate. The organic layer is then separated and then washed with water (2×20 ml) followed by drying with anhydrous sodium sulphate. The purified product is then obtained via flash chromatography using hexane and diethyl ether (10:1) as eluents.

### Example 5

Scheme 5 shows the two step synthesis of (F) 1-acetoxy-1,2,3,4-tetrahydronaphthalene and (G) 1-acetoxy-4-trifluoroacetoxy-1,2,3,4-tetrahydronaphthalene.

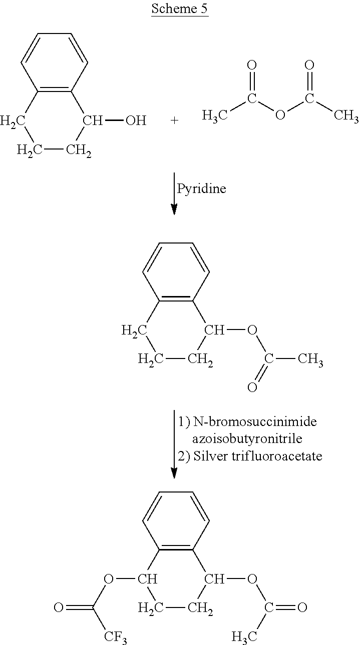

(F) 1-acetoxy-1,2,3,4-tetrahydronaphthalene: An excess of acetic anhydride (144 mL, 1.51 mol) was added to a solution of 1,2,3,4-tetrahydronaphthalen-1-ol (51.2 g, 345.5 mmol) in pyridine (200 mL). The mixture was stirred for 2 days at room temperature. The volatile components were removed under reduced pressure, diethyl ether (1 L) was added, and the solution was transferred to a separatory funnel. The ethereal solution was washed with diluted aqueous hydrochloric acid (1%, 500 mL) and then with saturated aqueous NaCl solution (500 mL). The extract was dried (MgSO4) and then concentrated under reduced pressure to yield the crude acetate. Distillation under reduced pressure yielded 60.0 g, 92% yield based on 1,2,3,4-tetrahydronaphthalen-1-ol (bp 84° C./0.4 mmHg), 6H (300 MHz, CDCl3,) 1.78-2.06 (4 H, m, 3-H, 3′-H, 2-H, 2′- H), 2.06 (3 H, s, OCOCH3), 2.73-2.88 (2 H, m, 4-H, 4′-H), 5.98 (1 H, t, 1 -H) and 7.09-7.26 (4 H, m, Ar-H).

(G) 1-acetoxy-4-trifluoroacetoxy-1,2,3,4-tetrahydronaphthalene: A solution of (F) 1-acetoxy-1,2,3,4-tetrahydronaphthalene (30.0 g, 157.8 mmol) in cyclohexane (1 L) was heated to 50° C. with a heating mantel. N-Bromosuccinimide (30.9 g, 173.6 mmol) and a catalytic amount of azoisobutyronitrile (ca. 0.040 g) were added and the solution was heated to the reflux for 2 h. The solution was cooled, filtered (paper filter) and concentrated under reduced pressure to yield a mixture of cis- and trans-1-acetoxy-4-bromo-1,2,3,4-tetrahydronaphthalene as a yellowish oil that is then dissolved in 1.3 L of ice-cold toluene. A suspension of silver trifluoroacetate (87 g, 394 mmol) in toluene (600 mL) was then added to the cooled solution. The reaction was stirred for 5 hours at room temperature followed by filtering of the silver bromide precipitate. The organic filtrate was concentrated under reduced pressure to yield (G) 1-acetoxy-4-trifluoroacetoxy-1,2,3,4-tetrahydronaphthalene as a brown oil. ¹H NMR analysis confirmed quantitative formation of the trifluoroacetoxy derivative based on (F) 1-acetoxy-1,2,3,4-tetrahydronaphthalene. δH (300 MHz, CDCl3) 2.07 (3 H, s, OCOMeA), 2.13 (3 H, s, OCOMeB), 2.09-2.39 (8 H, m, 2-HA, 2′-HA, 2-HB, 2′-HB, 3-HA, 3′-HA, 3-HB, 3′-HB), 5.97-6.20 (4 H, m, 1-HA, 1-HB, 4-HA, 4-HB), 7.29-7.48 (8 H, m, Ar-H).

### Example 6

Scheme 6 shows the one step synthesis of (H) 1,2,3,4-tetrahydronaphthalene, 1,1′-bis(tetrahydropyranyl ether)-.

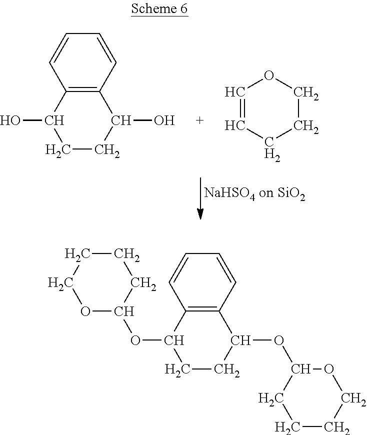 [SMILES: OC1CCC(O)c2ccccc21 ; C1=COCCC1 ; c1ccc2c(c1)C(OC1CCCCO1)CCC2OC1CCCCO1]

(H) 1,2,3,4-tetrahydronaphthalene, 1,1′-bis(tetrahydropyranyl ether)-: To a mixture of 1,4-dihydoxy-1,2,3,4-tetrahydronaphthalene (1.67 mmol) and dihydro-4H-pyran (10 mmol), NaHSO₄ on silica (3 mg, 3 mmol NaHSO₄/g) is added and the mixture is stirred at room temperature for 16 hours or until thin-layer chromatography analysis shows the complete disappearance of 1,4-dihydoxy-1,2,3,4-tetrahydronaphthalene. After completion of the reaction, the mixture is directly loaded onto silica gel for flash chromatographic purification using 1:9 ethyl acetate-hexane eluent. The pure product is obtained as a white powder.

### Example 7

Scheme 7 shows the one step synthesis of (I) 1,2,3,4-tetrahydronaphthalene, 1,1′-bis(methoxymethoxy)-.

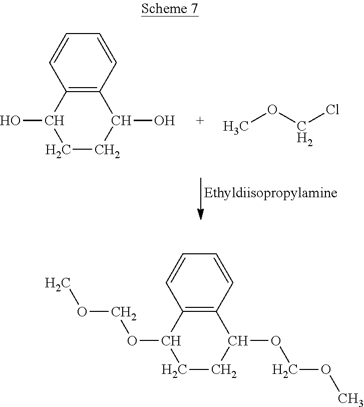

(I) 1,2,3,4-tetrahydronaphthalene, 1,1′-bis(methoxymethoxy)-: A solution of 1,4-dihydoxy-1,2,3,4-tetrahydronaphthalene (3.0 g, 18.3 mmol) in dichloromethane (36 ml) is cooled to 0° C. Then ethyldiisopropylamine (10 ml) and chloromethyl methyl ether (4.2 ml, 55 mmol) are slowly added to the solution. The reaction solution is allowed to slowly warm to room temperature while continuously stirring overnight. After at least 14 hours of stirring, the resulting yellow solution is poured into an aqueous solution of ammonium chloride (50% saturated, 60 ml). The resulting mixture is extracted with dichloromethane (2×20 ml) and then the organic phase is collected and dried with Na₂SO₄. The organic phase is then passed through a short silica plug to remove trace impurities using diethyl ether to elute the absorbed product. The colorless solution is then concentrated under vacuum to afford the pure compound.

### Example 8

Scheme 8 shows the one step synthesis of (J) poly(1,2,3,4-tetrahydronaphthalene-1,4-diol carbonate) through a reaction with (A) 1,1′-(1,2,3,4-Tetrahydro-1,4-naphthalenediyl) di-1H-imidazole-1-carboxylate.

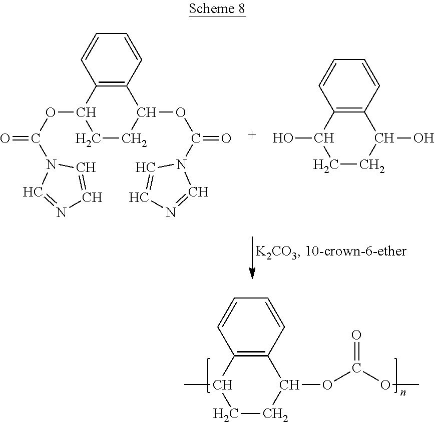

(J) Poly(1,2,3,4-tetrahydronaphthalene-1,4-diol carbonate): In an ampule with a PTFE stopcock, 1,4-dihydoxy-1,2,3,4-tetrahydronaphthalene (12.9 g, 78.6 mmol), (A) 1,2,3,4-tetrahydronaphthalene-1,4-diyl bis(1H-imidazole- 1-carboxylate) (27.7 g, 78.6 mmol), 18-crown-6 (4.3 g, 16.0 mmol) and anhydrous potassium carbonate anhydrous (56.9 g, 412 mmol) were combined. This ampule was connected to a high vacuum pump and the materials engaged were further dried for 24 h. Dry CH2Cl2 (430 mL) was added. The sealed ampule was stirred magnetically and heated in an oil bath at 45° C. for 5 days under nitrogen. At the end of the reaction, more CH2Cl2 (250 mL) and a saturated solution of sodium bicarbonate (250 mL) were added to the ampule. The reaction mixture was transferred to a separatory funnel and the lower organic phase was removed. The aqueous phase was extracted with CH2Cl2 (200 mL×2) and the CH2Cl2 extracts were combined. The dichloromethane solution was then washed with deionized water (150 mL×2), a saturated solution of sodium bicarbonate (150 mL×3), again with deionized water (150 mL×3) and dried over anhydrous MgSO4. After filtration, the solution was concentrated on a rotary evaporator and the polymer was precipitated in methanol (600 mL). The polymer was recovered as a beige powder by filtration and washed with MeOH (100 mL), collected, and dried under vacuum for 24 h at room temperature with a yield of 79% based on 1,4-dihydoxy-1,2,3,4-tetrahydronaphthalene and (A) 1,2,3,4-tetrahydronaphthalene-1,4-diyl bis(1H-imidazole-1-carboxylate).

Table 2 shows the number average molecular weight (Mn), weight average molecular weight (Mw) and polydispersity index (Mw/Mn) the polymers synthesized.

TABLE 2

| Batch | | | | Trans/Cis |
|---|---|---|---|---|
| No. | Mn (g/mol) | Mw (g/mol) | Mw/Mn | Isomer Ratio |
| 1 | 2400 | 4200 | 2.5 | 62/38 |
| 2 | 2420 | 3000 | 1.2 | — |
| 3 | 2500 | 3370 | 1.4 | — |
| 4 | 4110 | 6620 | 1.6 | — |
| 5 | 3310 | 4530 | 1.4 | — |
| 6 | 2950 | 4070 | 1.4 | — |
| 7 | 4280 | 6220 | 1.5 | — |
| 8 | 1950 | 2350 | 1.2 | — |
| 9 | 2020 | 2830 | 1.4 | — |

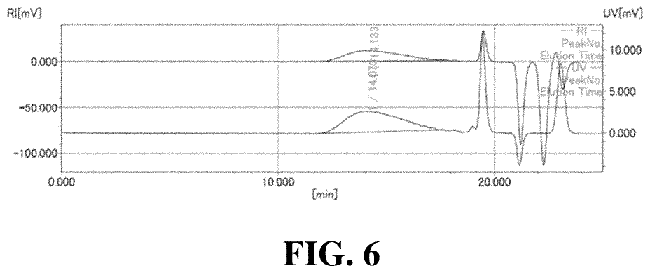

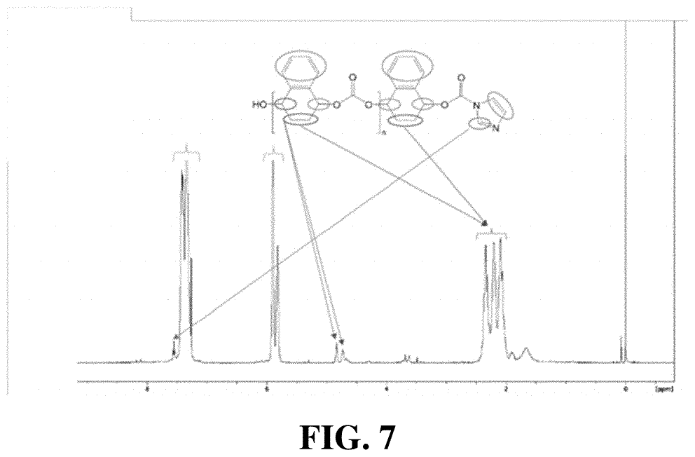

FIG. 6 depicts a gel permeation chromatography trace with a UV and refractive index detector used for determination of molecular weight distribution of polymers synthesized by the method of Example 8, and Table 3 shows the calculated molecular weight (Mn and Mw) and molecular weight distribution values based on the chromatography trace using polystyrene as a reference standard, where chromatography was performed using THF as the mobile phase.

TABLE 3
<Result of Molecular Weight Calculation> (RI)

| | | |
|---|---|---|
| [min] | [mV] | [mol] |

Peak1Base Peak

| | | | | | |
|---|---|---|---|---|---|
| Peak Start | 11.748 | −0.025 | 53582 | Mn | 4114 |
| Peak Top | 14.133 | 11.777 | 6398 | Mw | 6620 |
| Peak End | 17.820 | 1.212 | 800 | Mz | 10332 |
| Height [mV] | | | 11.316 | Mz + 1 | 14844 |
| Area [mV s] | | | 1999.171 | Mv | 6620 |
| Area % [%] | | | 100.000 | Mp | 5278 |
| [Eta] | | | 6619.76337 | Mz/Mw | 1.561 |
| | | | | Mw/Mn | 1.609 |
| | | | | Mz + 1/Mw | 2.242 |

Total

| | | | | | |
|---|---|---|---|---|---|
| Peak Start | 11.748 | −0.025 | 53582 | Mn | 4114 |
| Peak Top | 14.133 | 11.777 | 6398 | Mw | 6620 |
| Peak End | 17.820 | 1.212 | 800 | Mz | 10332 |
| Heigh [mV] | | | 11.316 | Mz + 1 | 14844 |
| Area [mV s] | | | 1999.171 | Mv | 6020 |
| Area % [%] | | | 100.000 | Mp | 5278 |
| [Eta] | | | 6619.76337 | Mz/Mw | 1.561 |
| | | | | Mw/Mn | 1.609 |
| | | | | Mz + 1/Mw | 2.242 |

### Example 9

Scheme 9 shows the one step synthesis of (K) poly(1,2,3,4-tetrahydronaphthalene-1,4-diol formal).

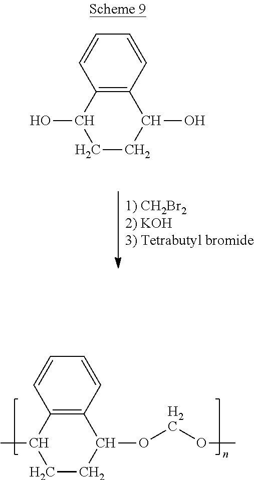

(K) Poly(1,2,3,4-tetrahydronaphthalene-1,4-diol formal): In a 250 mL round-bottom flask, 1,4-dihydoxy-1,2,3,4-tetrahydronaphthalene (1.64 g, 10.0 mmol), tetrabutylammonium bromide (0.52 g, 1.6 mmol) and dibromomethane (2.2 mL, 31.6 mmol) are added. Then an aqueous KOH solution (20 mL, 60 wt %) is added. The reaction mixture is stirred magnetically and vigorously at room temperature for 24 h. At the end of the reaction, dichloromethane (30 mL) is added to the reaction flask. The reaction mixture is transferred to a separatory funnel (250 mL) and the lower organic phase is removed. The aqueous phase is washed with dichloromethane (30 mL×2) and all the dichloromethane solutions are combined. These are then washed with deionized water (30 mL×3) and then are dried over anhydrous MgSO₄. After filtration, the solvent is removed by rotary evaporation. The product, a white powder, is dried in air overnight in a fume hood and then in a vacuum oven for 24 hours at room temperature.

### Example 10

Scheme 10 shows the one step synthesis of (L) poly(1,2,3,4-tetrahydronaphthalene-1,4-diol-alt-α,α′-dibromo-p-xylene).

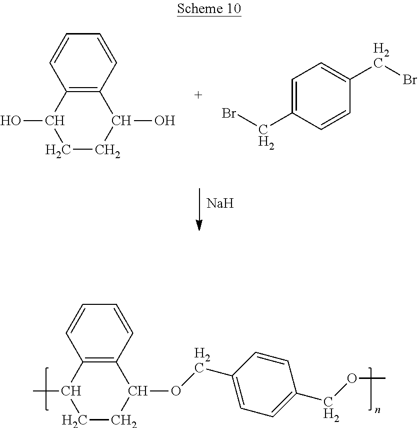

(L) Poly(1,2,3,4-tetrahydronaphthalene-1,4-diol-alt-α,α′-dibromo-p-xylene): α,α′-Dibromo-o-xylene, (2.64 g, 10 mmol) and 1,4-dihydoxy-1,2,3,4-tetrahydronaphthalene (1.64 g, 10 mmol) are dissolved in dry THF (125 mL). This solution is added dropwise to a suspension of NaH (1.5 g) in dry THF (300 mL) under an inert atmosphere. The mixture is stirred under reflux for 24 hours and then allowed to cool at room temperature. To this solution enough water (150 mL) is added dropwise to consume the excess NaH and dissolve the resulting NaBr and NaOH. The THF-water mixture is extracted with ethyl ether (4×100 mL), and the combined organic extracts are washed with 100 mL saturated NaHCO₃ solution, with 100 mL saturated NaCl solution, and finally with 100 mL water. The organic layer is dried over anhydrous Na₂SO₄ and filtered. The solution is concentrated and then polymer is precipitated by dropwise addition into ice-cold methanol to afford the desired polymer. The white-yellow powder is dried under vacuum for 48 hours to afford the purified product.

### Example 11

Scheme 11 shows the one step synthesis of (M) 1,4,9,12-tetraoxadispiro[4.2.4.2]tetradeca-6,13-diene.

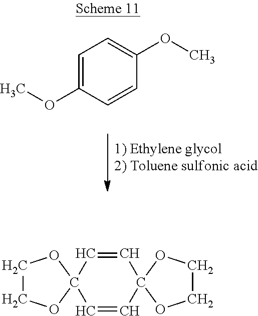

(R) 1,4,9,12-tetraoxadispiro[4.2.4.2]tetradeca-6,13-diene: 1000 g (5 mol) of 3,3,6,6-tetramethoxycyclohexa-1,4-dione is suspended in 2000 ml of 1,2-ethanediol. At 5° C. 0.6 g of p-toluenesulphonic acid is added at 5° C., and the suspension is stirred at the same temperature for 2 hours. The reaction is followed by gas chromatography. To complete the precipitation, the reaction mixture is cooled to 0° C. The solid is filtered off, washed with 1000 ml of cold water and dried at room temperature under vacuum to afford the pure product.

### Example 12

A release layer formulation comprising (J) Poly(1,2,3,4-tetrahydronaphthalene-1,4-diol carbonate), diphenyl ether, quinoline, and the photoacid generator (PAG) (4-Phenylthiophenyl)diphenylsulfonium trifluoromethanesulfonate, shown in Scheme 12, are prepared and a release layer is deposited.

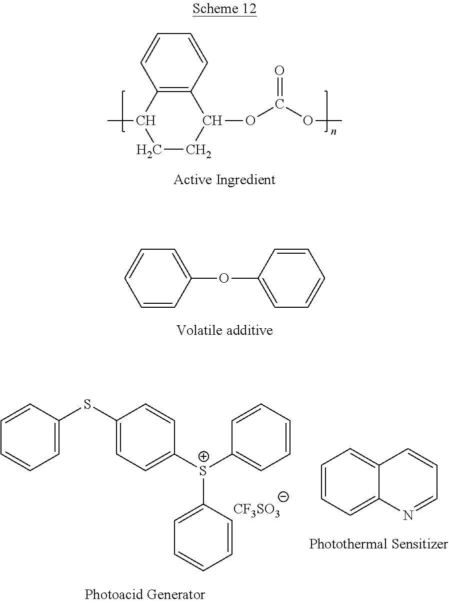

Solutions of each component are prepared by dissolving 1.0 g in 3.33 g of propylene glycol monomethyl ether (PGMEA) and then filtering each solution through a 450 nm PTFE syringe filter. Solutions are then mixed and diluted with filtered PGMEA to create a solution of 10 wt % (J) Poly(1,2,3,4-tetrahydronaphthalene-1,4-diol carbonate), 0.3 wt % diphenyl ether, 0.3 wt % quinoline, and 0.5 wt % PAG. 100 μl of the formulated solution is then dynamically spin-coated onto a 2-inch diameter fused silica disk with a spin rate of 2000 rpm for 60 s. The release layer coated disk is then soft-baked for 120 seconds at 150° C. and then is cooled to room temperature prior to attaching small-components for transfer.

### Example 13

A release layer formulation comprising (L) Poly(1,2,3,4-tetrahydronaphthalene-1,4-diol-alt-α,α′-dibromo-p-xylene), (B) 1,1′-(1,2,3,4-Tetrahydro-1,4-naphthalenediyl) di-tert-butyl carbonate, dibenzothiophene, and the PAG (4-Phenylthiophenyl)diphenylsulfonium trifluoromethanesulfonate, shown in Scheme 13, are prepared and a release layer is deposited.

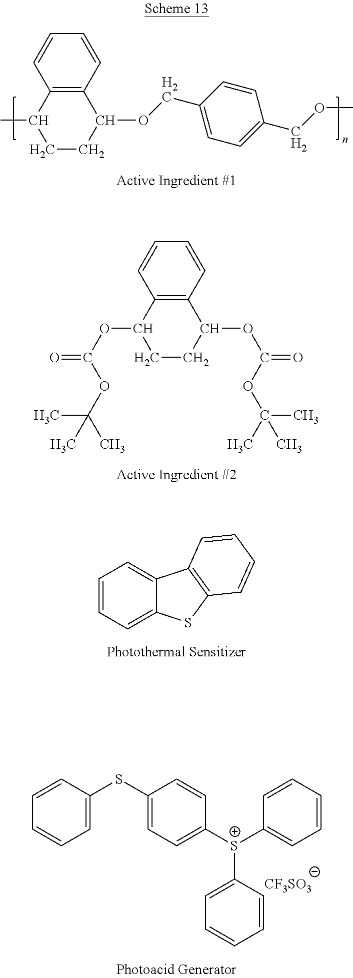

Solutions of each component are prepared by dissolving 1.0 g in 3.33 g of PGMEA and then filtering each solution through a 450 nm PTFE syringe filter. Solutions are then mixed and diluted with filtered PGMEA to create a solution of 5 wt % (J) Poly(1,2,3,4-tetrahydronaphthalene-1,4-diol carbonate), 10 wt % (B) 1,1′-(1,2,3,4-Tetrahydro-1,4-naphthalenediyl) di-tert-butyl carbonate, 0.3 wt % dibenzothiophene, and 0.5 wt % PAG. 100 μl of the formulated solution is then dynamically spin-coated onto a 2-inch diameter fused silica disk with a spin rate of 2000 rpm for 60 s. The release layer coated disk is then soft-baked for 120 seconds at 150° C. and then is cooled to room temperature prior to attaching small-components for transfer.

### Example 14A

A release layer formulation comprising (H) 1,2,3,4-tetrahydronaphthalene, 1,1′-bis(tetrahydropyranyl ether)-, poly(bisphenol A carbonate) (Mₙ=50,000 g/mol), and p-toluenesulfonic acid, shown in Scheme 14, are prepared and a release layer is deposited.

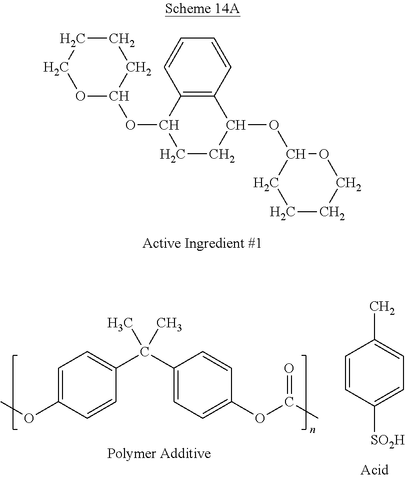

Solutions of each component are prepared by dissolving 1.0 g in 3.33 g of (PGMEA) and then filtering each solution through a 450 nm PTFE syringe filter. Solutions are then mixed and diluted with filtered PGMEA to create a solution of 5 wt % (H) 1,2,3,4-tetrahydronaphthalene poly(bisphenol A carbonate) (Mₙ=50,000 g/mol), and 0.02 wt % p-toluenesulfonic acid. 100 μl of the formulated solution is then dynamically spin-coated onto a 2-inch diameter fused silica disk with a spin rate of 2000 rpm for 60 s. The release layer coated disk is then soft-baked for 120 seconds at 150° C. and is then cooled to room temperature prior to attaching small-components for transfer.

### Example 14B

A release layer formulation comprising (H) 1,2,3,4-tetrahydronaphthalene, 1,1′-bis(tetrahydropyranyl ether)-, poly(bisphenol A carbonate) (Mₙ=50,000 g/mol), and PAG, shown in Scheme 14, are prepared and a release layer is deposited.

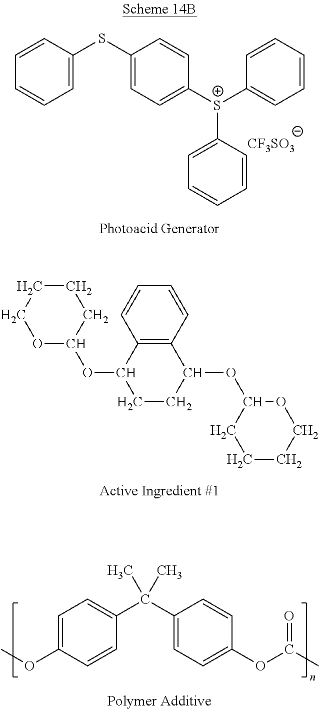

Solutions of each component are prepared by dissolving 1.0 g in 3.33 g of (PGMEA) and then filtering each solution through a 450 nm PTFE syringe filter. Solutions are then mixed and diluted with filtered PGMEA to create a solution of 5 wt % (H) 1,2,3,4-tetrahydronaphthalene poly(bisphenol A carbonate) (Mₙ=50,000 g/mol), and 0.5 wt % PAG. 100 μl of the formulated solution is then dynamically spin-coated onto a 2-inch diameter fused silica disk with a spin rate of 2000 rpm for 60 s. The release layer coated disk is then soft-baked for 120 seconds at 150° C. and then is cooled to room temperature prior to attaching small-components for transfer.

### Example 15

A release layer formulation comprising (J) Poly(1,2,3,4-tetrahydronaphthalene-1,4-diol carbonate) and the photoacid generator (PAG) (4-Phenylthiophenyl)diphenylsulfonium trifluoromethanesulfonate, shown in Scheme 15, were prepared and release layer was deposited. For the purposes of characterization and experimentation data included was obtained using a batch of (J) with a Mₙ of 2,700 g/mol and a M_{w} of 4,100 g/mol.

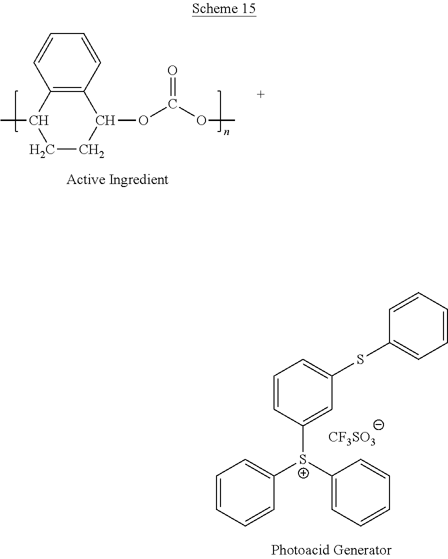

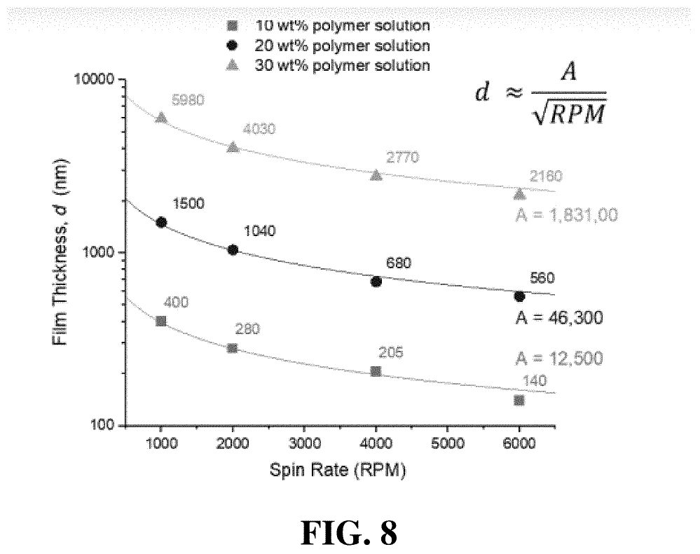

Solutions of each component were prepared by dissolving 1.0 gin 3.33 g of (PGMEA) and then filtering each solution through a 450 nm PTFE syringe filter. Solutions were then mixed and diluted with filtered PGMEA to create a solutions of 10, 20, and 30 wt % (J) Poly(1,2,3,4-tetrahydronaphthalene-1,4-diol carbonate) and variable amounts of PAG, depending on the desired concentration of catalyst to polymer. 100 μl of the formulated solutions were then spin-coated onto a 2-inch by 2-inch diameter fused silica plates with spin rates between 1000 and 6000 rpm for 60s depending on desired thicknesses, and the thicknesses vs. spin rates results are depicted in FIG. 8.

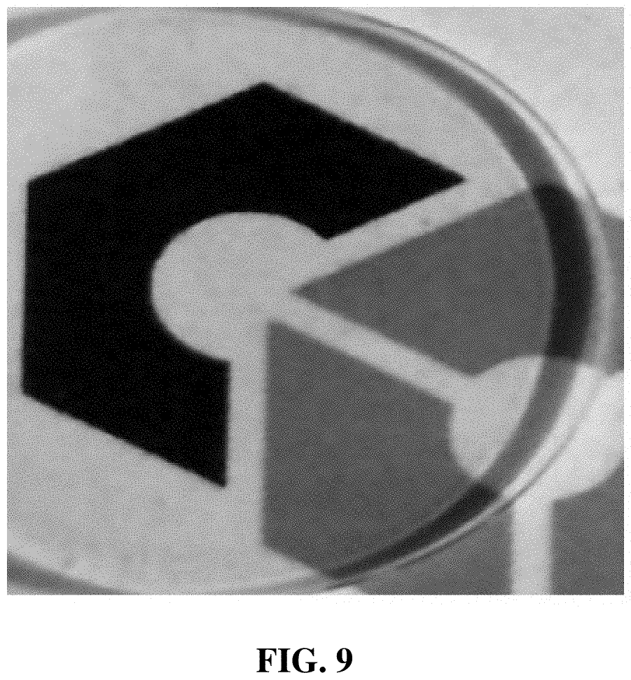

Films containing 1, 2, 3, 3.5, 5, 10, and 19 wt % PAG were prepared and tested for their ability to form stable release layer coatings and transfer components, and were studied using a 266 nm YAG laser to perform laser induced transfers. The release layer coated plates were then soft-baked for 120 seconds at 150° C. and then cooled to room temperature prior to attaching small-components for transfer. FIG. 9 shows an example of a fused silica donor plate coated with a 1.6 μm of such a release layer film containing 3 wt % PAG, and demonstrates the optical transparency and homogeneity of the thin film coating.

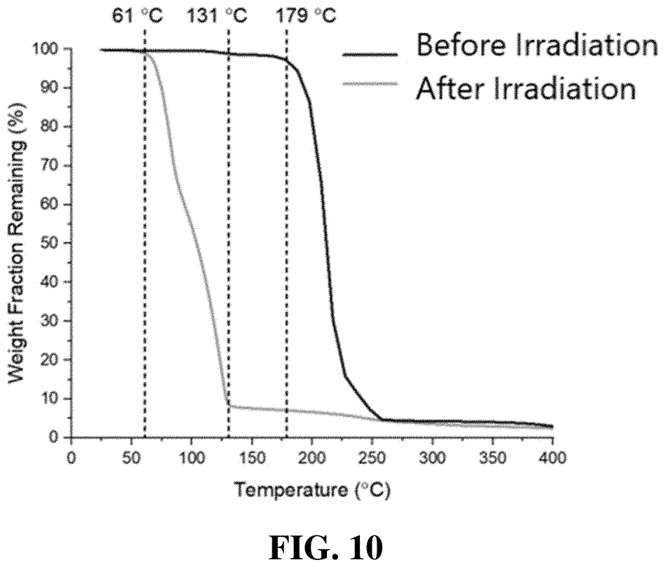

Decomposition analysis of the Example 15 release layer formulation with an active ingredient with an Mn of 2500 g/mol and Mw of 3370 g/mol, combined with 3.5 wt % PAG was carried out and demonstrate that the material decomposes into volatile small molecules as designed when activated by UV light. FIG. 10 shows the decomposition temperature of the material before and after exposure to 311 nm light. Prior to activation of the photoacid generator, decomposition occurs at 179° C. when heated at a steady rate of 10° C. per minute with decomposition completing at ˜250° C. After UV exposure, the material begins decomposing at 61° C. and reaches the maximum decomposition around 131° C. This demonstrates the ability to fully decompose light activated areas of the film at temperatures below the decomposition temperatures of the regions that are not light activated.

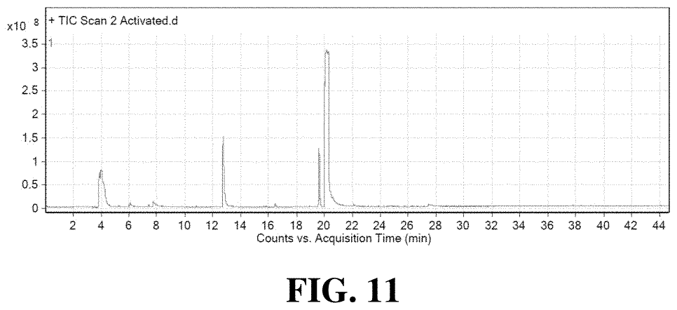

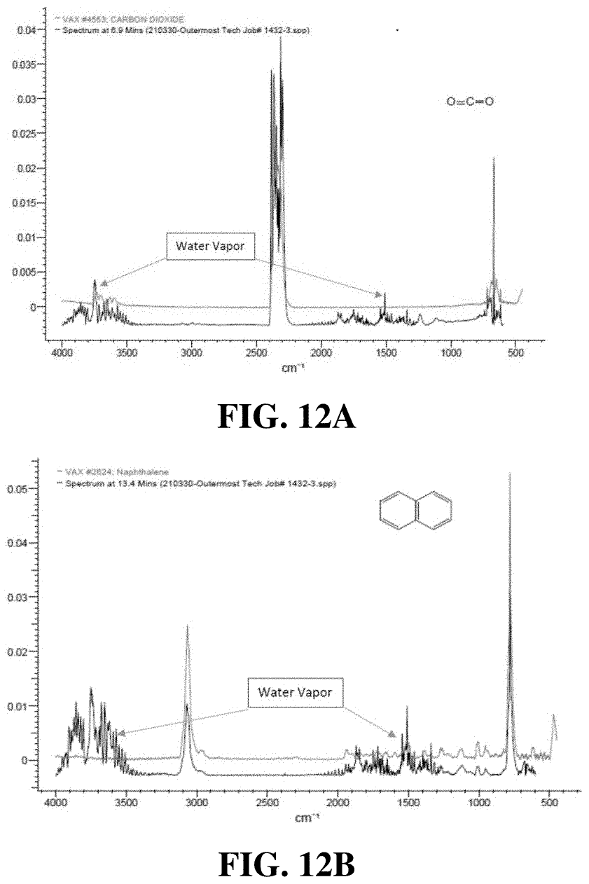

FIGS. 11, 12A and 12B show the results of analyzing the vaporous decomposition products of the activated release layer when heated at 150° C. The analysis confirms that the primary products of the decomposition are water, carbon dioxide, and naphthalene, as predicted by the materials hypothesized decomposition mechanism when catalyzed by the photoacid generator.

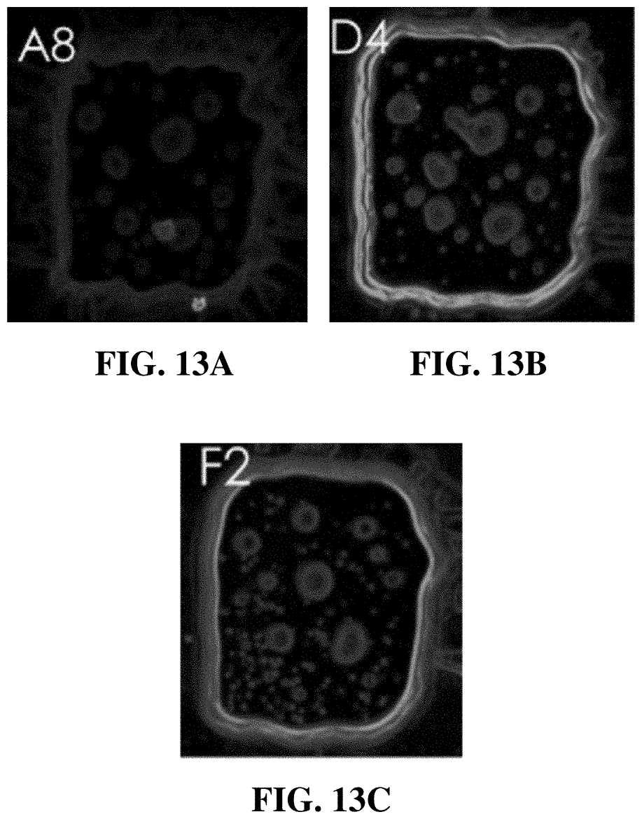

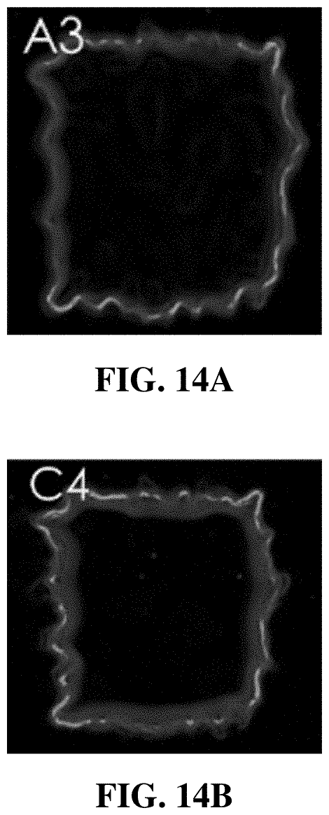

FIGS. 13A-14B demonstrate the decomposition behavior of the material under component transfer relevant conditions when irradiated with a 266 nm UV laser. Laser profilometry analysis of the craters show that craters are developed with depths spanning the full thickness of the film when formulated with 5 wt % PAG and while being heated to 110° C. with an external heat source. It is important to note that the successful transfer from components from the loaded donor plate does not require complete decomposition of the material at the exposed area. Transfer can be attained with <1% decomposition of the material if enough force is generated by the vaporous decomposition products when irradiated.

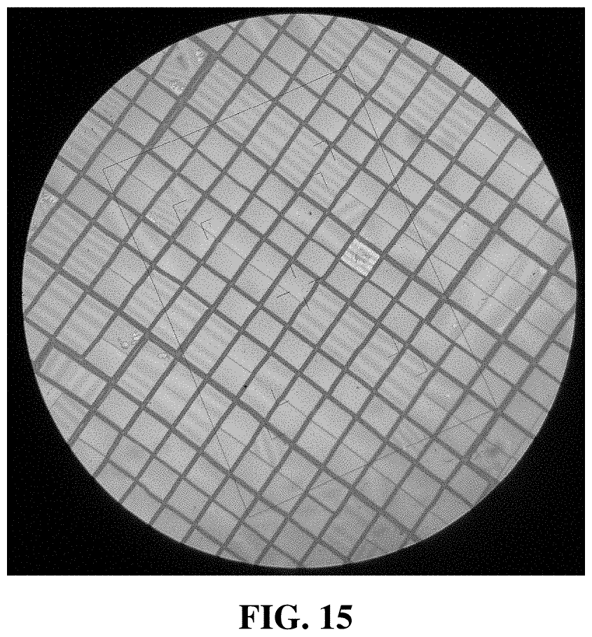

The release layer of Example 15 was coated onto a donor plate and utilized to transfer components from their source carriers to a target substrate, including die attached to a 0.9 μm release layer, 5 μm diameter microLEDs attached to a 0.23 μm release layer, and 50 μm by 60 μm silicon chips attached to a 1 μm film as shown in FIG. 15. Components may be loaded from carrier substrates onto a donor plate comprising the release layer, and released onto a target substrate as described with regard to FIG. 1.

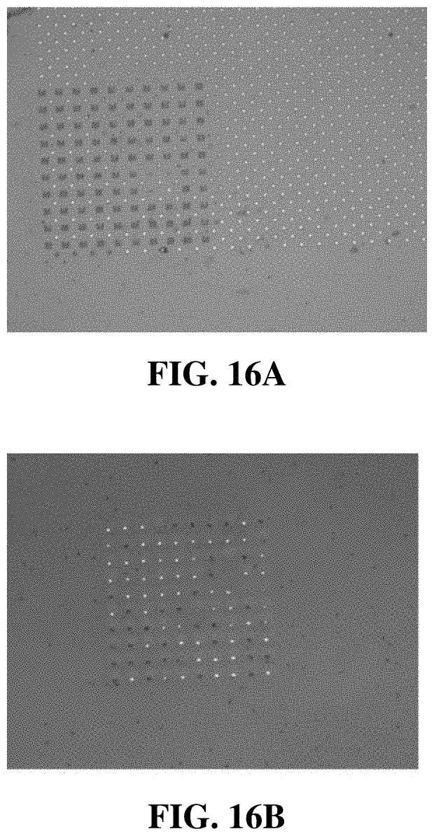

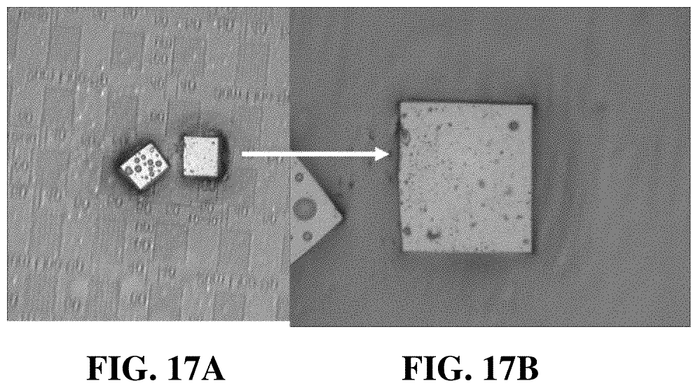

FIGS. 16A-17B depict components of multiple size scales that have been transferred to target substrates using donor plates comprising the release layer of Example 15. FIGS. 16A and 16B show the transfer results of 5 μm diameter microLEDs from a coated donor plate to a pressure sensitive adhesive (PSA). Transfers were conducted by irradiating individual microLED locations with a single 266 nm laser pulse with a total fluence of 500 mJ/cm2. FIGS. 17A and 17B show the transfer of results of 50 μm by 60 μm silicon die from a coated donor plate to a target substrate coated with a PSA with a single 266 nm laser pulse with a total fluence of 30 mJ/cm2.

### Example 16

A release layer formulation comprising (D) 1,1′-(1,2,3,4-Tetrahydro-1,4-naphthalenediyl) di-1-(1,2,3,4-tetrahydro-1,4-napthalenediyl) carbonate, poly(propylene carbonate) (Mn=50,000 g/mol), and the PAG (4-Phenylthiophenyl)diphenylsulfonium trifluoromethanesulfonate, shown in Scheme 16, is prepared and a release layer is deposited.

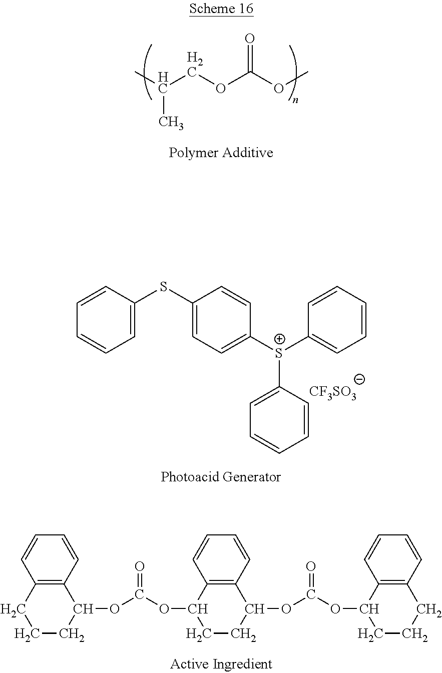

Solutions of each component were prepared by dissolving 1.0 g in 3.33 g of propylene glycol monomethyl ether (PGMEA) and then filtering each solution through a 450 nm PTFE syringe filter. Solutions were then mixed and diluted with filtered PGMEA to create a solution of 10 wt % poly(propylene carbonate), 1 wt % (D) 1,1′-(1,2,3,4-Tetrahydro-1,4-naphthalenediyl) di-1-(1,2,3,4-tetrahydro-1,4-napthalenediyl) carbonate, and 0.5 wt % PAG. 100 μl of the formulated solution was then dynamically spin-coated onto a 2-inch diameter fused silica disk with a spin rate of 2000 rpm for 60 s. The release layer coated disk was then soft-baked for 120 seconds at 150° C. and then cooled to room temperature prior to attaching small-components for transfer.

### Example 17

A release layer formulation comprising (I) 1,2,3,4-tetrahydronaphthalene, 1,1′-bis(methoxymethoxy)-, poly(propylene carbonate) (Mn=50,000 g/mol), and the PAG (4-Phenylthiophenyl)diphenylsulfonium trifluoromethanesulfonate, shown in Scheme 17, is prepared and a release layer is deposited.

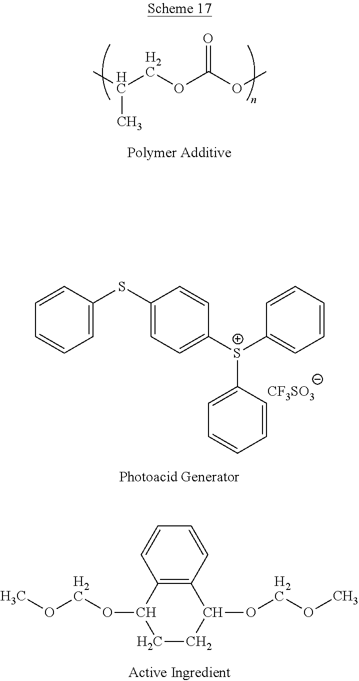

Solutions of each component were prepared by dissolving 1.0 g in 3.33 g of propylene glycol monomethyl ether (PGMEA) and then filtering each solution through a 450 nm PTFE syringe filter. Solutions were then mixed and diluted with filtered PGMEA to create a solution of 10 wt % poly(propylene carbonate), 1 wt % (I) 1,2,3,4-tetrahydronaphthalene, 1,1′-bis(methoxymethoxy)-, and 0.5 wt % PAG. 100 μl of the formulated solution was then dynamically spin-coated onto a 2-inch diameter fused silica disk with a spin rate of 2000 rpm for 60 s. The release layer coated disk was then soft-baked for 120 seconds at 150° C. and then cooled to room temperature prior to attaching small-components for transfer.

### Example 18

A release layer formulation comprising (J) poly(1,2,3,4-tetrahydronaphthalene-1,4-diol carbonate)-, poly(propylene carbonate) (Mn=50,000 g/mol), and the PAG (4-Phenylthiophenyl)diphenylsulfonium trifluoromethanesulfonate, shown in Scheme 18, is prepared and a release layer is deposited.

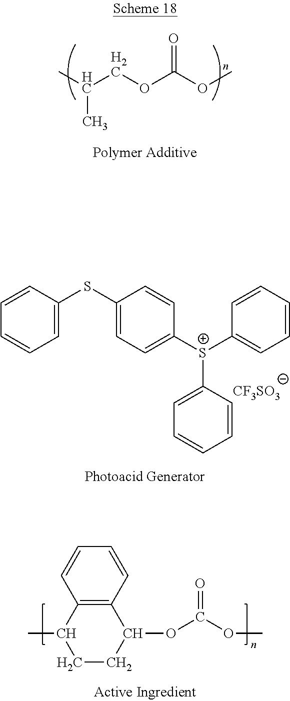

Solutions of each component were prepared by dissolving 1.0 g in 3.33 g of propylene glycol monomethyl ether (PGMEA) and then filtering each solution through a 450 nm PTFE syringe filter. Solutions were then mixed and diluted with filtered PGMEA to create a solution of 10 wt % poly(propylene carbonate), 5 wt % (J) poly(1,2,3,4-tetrahydronaphthalene-1,4-diol carbonate)-, and 0.5 wt % PAG. 100 μl of the formulated solution was then dynamically spin-coated onto a 2-inch diameter fused silica disk with a spin rate of 2000 rpm for 60 s. The release layer coated disk was then soft-baked for 120 seconds at 150° C. and then cooled to room temperature prior to attaching small-components for transfer.

### Example 19

A release layer formulation comprising (E) naphthalene, di-1,1′-(1,1-dimethylethoxy)-1,2,3,4-tetrahydro-, poly(n-butyl acrylate) (Mn=20,000 g/mol), and the PAG (4-Phenylthiophenyl)diphenylsulfonium trifluoromethanesulfonate, shown in Scheme 19, is prepared and a release layer is deposited.

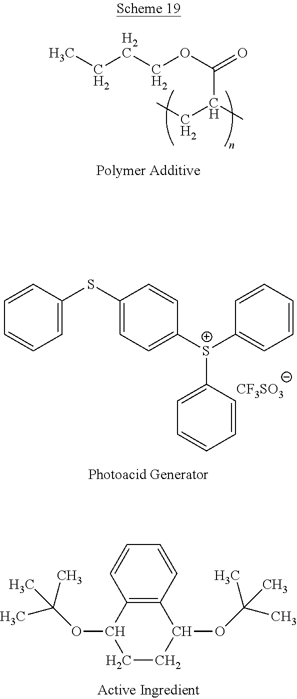

Solutions of each component were prepared by dissolving 1.0 g in 3.33 g of propylene glycol monomethyl ether (PGMEA) and then filtering each solution through a 450 nm PTFE syringe filter. Solutions were then mixed and diluted with filtered PGMEA to create a solution of 10 wt % poly(butyl acrylate), 1 wt % (E) naphthalene, di-1,1′-(1,1-dimethylethoxy)-1,2,3,4-tetrahydro-, and 0.5 wt % PAG. 100 μl of the formulated solution was then dynamically spin-coated onto a 2-inch diameter fused silica disk with a spin rate of 2000 rpm for 60 s. The release layer coated disk was then soft-baked for 120 seconds at 150° C. and then cooled to room temperature prior to attaching small-components for transfer.

### Example 20

A release layer formulation comprising (M) 1,4,9,12-tetraoxadispiro[4.2.4.2]tetradeca-6,13-diene, poly(n-butyl acrylate) (Mn=20,000 g/mol), and the PAG (4-Phenylthiophenyl)diphenylsulfonium trifluoromethanesulfonate, shown in Scheme 20, is prepared and a release layer is deposited.

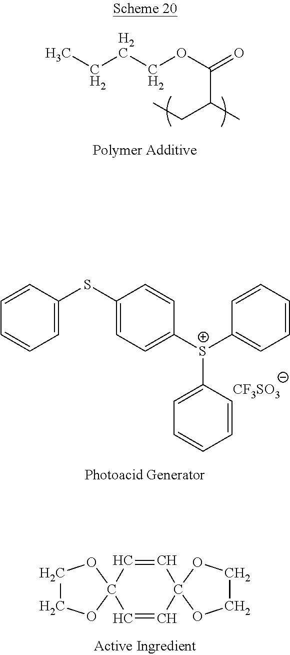

Solutions of each component were prepared by dissolving 1.0 g in 3.33 g of propylene glycol monomethyl ether (PGMEA) and then filtering each solution through a 450 nm PTFE syringe filter. Solutions were then mixed and diluted with filtered PGMEA to create a solution of 10 wt % poly(butyl acrylate), 1 wt % (M) 1,4,9,12-tetraoxadispiro[4.2.4.2]tetradeca-6,13-diene, and 0.5 wt % PAG. 100 μl of the formulated solution was then dynamically spin-coated onto a 2-inch diameter fused silica disk with a spin rate of 2000 rpm for 60 s. The release layer coated disk was then soft-baked for 120 seconds at 150° C. and then cooled to room temperature prior to attaching small-components for transfer.

### Example 21

A release layer formulation comprising (K) poly(1,2,3,4-tetrahydronaphthalene-1,4-diol formal), dibenzothiophene, and the PAG (4-Phenylthiophenyl)diphenylsulfonium trifluoromethanesulfonate, shown in Scheme 21, is prepared and a release layer is deposited.

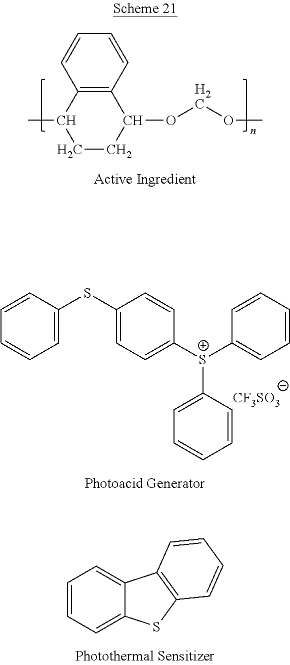

Solutions of each component were prepared by dissolving 1.0 g in 3.33 g of PGMEA and then filtering each solution through a 450 nm PTFE syringe filter. Solutions were then mixed and diluted with filtered PGMEA to create a solution of 10 wt % (K) poly(1,2,3,4-tetrahydronaphthalene-1,4-diol formal), 0.3 wt % dibenzothiophene, and 0.5 wt % PAG. 100 μl of the formulated solution was then dynamically spin-coated onto a 2-inch diameter fused silica disk with a spin rate of 2000 rpm for 60 s. The release layer coated disk was then soft-baked for 120 seconds at 150° C. and then cooled to room temperature prior to attaching small-components for transfer.

### Example 22

A release layer formulation comprising (J) poly(1,2,3,4-tetrahydronaphthalene-1,4-diol carbonate), (A) 1,1′-(1,2,3,4-Tetrahydro-1,4-naphthalenediyl) di-1H-imidazole-1-carboxylate, and the PAG (4-Phenylthiophenyl)diphenylsulfonium trifluoromethanesulfonate, shown in Scheme 22, is prepared and a release layer is deposited.

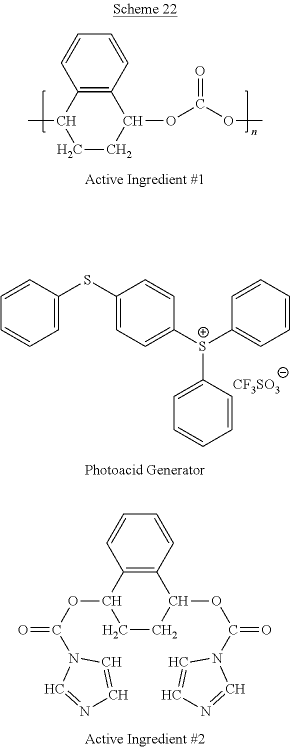

Solutions of each component were prepared by dissolving 1.0 gin 3.33 g of PGMEA and then filtering each solution through a 450 nm PTFE syringe filter. Solutions were then mixed and diluted with filtered PGMEA to create a solution of 10 wt % (J) poly(1,2,3,4-tetrahydronaphthalene-1,4-diol carbonate), 1 wt % (A) 1,1′-(1,2,3,4-Tetrahydro-1,4-naphthalenediyl) di-1H-imidazole-1-carboxylate, and 0.5 wt % PAG. 100 μl of the formulated solution was then dynamically spin-coated onto a 2-inch diameter fused silica disk with a spin rate of 2000 rpm for 60 s. The release layer coated disk was then soft-baked for 120 seconds at 150° C. and then cooled to room temperature prior to attaching small-components for transfer.

Although the foregoing has been described in some detail by way of illustrations and examples for purposes of clarity and understanding, it will be understood by those of skill in the art that numerous and various modifications can be made without departing from the spirit of the present disclosure. Therefore, it should be clearly understood that the forms disclosed herein are illustrative only and are not intended to limit the scope of the present disclosure, but rather to also cover all modification and alternatives coming with the true scope and spirit of the invention.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the components for an energy storage system described herein can be provided separately, or integrated together (e.g., packaged together, or attached together) to form an energy storage system.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount, depending on the desired function or desired result.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

The headings provided herein, if any, are for convenience only and do not necessarily affect the scope or meaning of the devices and methods disclosed herein.

What is claimed is:

1. A release layer composition, comprising an oligomeric component that comprises a unit of the Formula (I) and/or Formula (II): 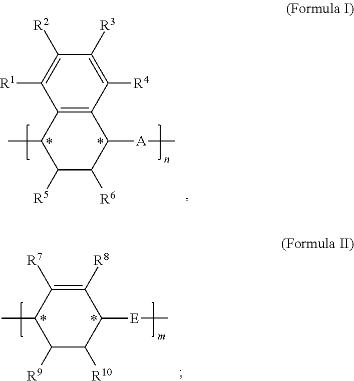
wherein:
each * denotes a chiral carbon;
n and m are independently an integer in the range of 1 to 15;
each A and E are independently —O—, —NH—, 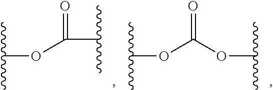
an optionally substituted 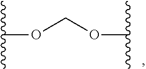 [SMILES: *OCO*]
an optionally substituted 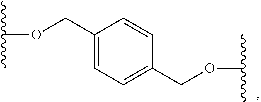 [SMILES: *OCc1ccc(CO*)cc1]
an optionally substituted 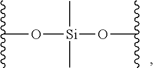 [SMILES: *O[Si](C)(C)O*]
an optionally substituted 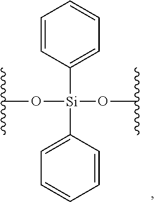 [SMILES: *O[Si](O*)(c1ccccc1)c1ccccc1]
an optionally substituted 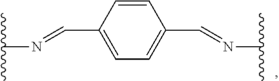 [SMILES: */N=C/c1ccc(/C=N/*)cc1]
an optionally substituted 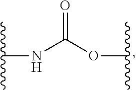 [SMILES: *NC(=O)O*]
an optionally substituted 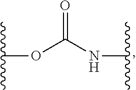 [SMILES: *NC(=O)O*]
an optionally substituted 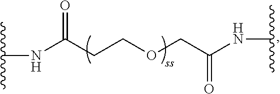
an optionally
substituted 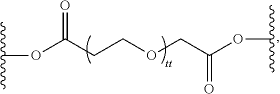
an optionally substituted 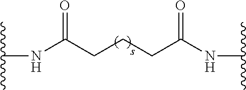
or an optionally substituted 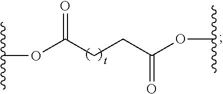
each R¹, R², R³, R⁴, R⁵, R⁶, R⁷, R⁸, R⁹ and R¹⁰ are independently hydrogen, halogen, C₁₋₁₀ alkyl, C₂₋₁₀ alkenyl or C₂₋₁₀ alkynyl; and
each ss, tt, s and t are independently an integer in the range of 1 to 10.

2. The release layer composition of claim 1, wherein R¹, R², R³, R⁴, R⁵, R⁶, R⁷, R⁸, R⁹ and R¹⁰ are hydrogen.

3. The release layer composition of claim 1, further comprising a polymeric component intermixed with the oligomeric component.

4. The release layer composition of claim 3, wherein the oligomeric component is present in the release layer composition in an amount that is greater than the amount of the polymeric component on a weight basis.

5. The release layer composition of claim 3, wherein the polymeric component comprises a unit of the formula (III) and/or Formula (IV): 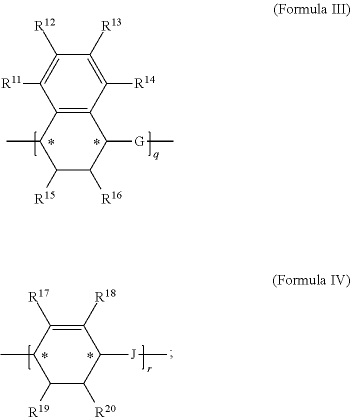
wherein:
each * denotes a chiral carbon;
q and r are independently an integer in the range of 16 to 200;
each G and J are independently —O—, —NH—, 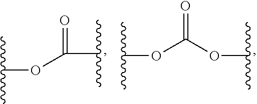
an optionally substituted 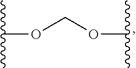 [SMILES: *OCO*]
an optionally substituted 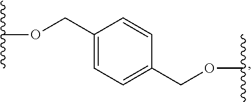 [SMILES: *OCc1ccc(CO*)cc1]
an optionally substituted 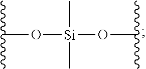 [SMILES: *O[Si](C)(C)O*]
an optionally substituted 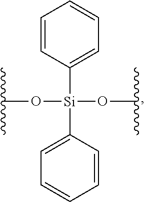 [SMILES: *O[Si](O*)(c1ccccc1)c1ccccc1]
an optionally substituted 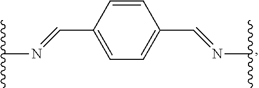 [SMILES: */N=C/c1ccc(/C=N/*)cc1]
an optionally substituted 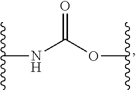 [SMILES: *NC(=O)O*]
an optionally substituted 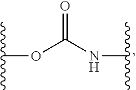 [SMILES: *NC(=O)O*]
an optionally substituted 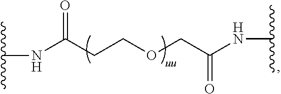
an optionally substituted 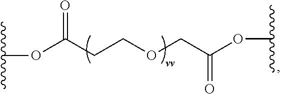
an optionally substituted 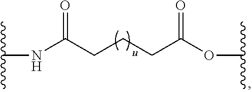
or an optionally substituted 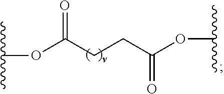
each R¹¹, R¹², R¹³, R¹⁴, R¹⁵, R¹⁶, R¹⁷, R¹⁸, R¹⁹ and R²⁰ are independently hydrogen, halogen, C₁₋₁₀ alkyl, C₂₋₁₀ alkenyl or C₂₋₁₀ alkynyl; and
each uu, vv, u and v are independently an integer in the range of 1 to 10.

6. The release layer composition of claim 5, wherein R¹¹, R¹², R¹³, R¹⁴, R¹⁵, R¹⁶, R¹⁷, R¹⁸, R¹⁹ and R²⁰ are hydrogen.

7. The release layer composition of claim 1, wherein the chiral carbons in Formula (I) and Formula (II) are selected so that the oligomeric component has a cis:trans ratio in a range from about 20:80 to about 80:20.

8. The release layer composition of claim 1, wherein the oligomeric component comprises a number averaged molecular weight (Mn) of about 1000-5000 g/mol.

9. The release layer composition of claim 1, wherein the oligomeric component comprises a weight averaged molecular weight (Mw) of about 2000-7000 g/mol.

10. The release layer composition of claim 9, wherein the Mw:Mn ratio of the oligomeric component is about 1:1 to 4:1.

11. The release layer composition of claim 1, wherein the oligomeric component comprises a glass transition temperature (T_{g}) of about −50-200° C.

12. The release layer composition of claim 1, further comprising an amount of a catalyst that is effective to catalyze decomposition of the oligomeric component in the presence of radiation.

13. The release layer composition of claim 12, wherein the catalyst comprises an acid catalyst, a base catalyst, or a combination thereof.

14. The release layer composition of claim 13, wherein the acid catalyst is a photoacid generator (PAG).

15. The release layer composition of claim 12, wherein the release layer composition comprises about 1-20 wt % of the catalyst.

16. The release layer composition of claim 1, further comprising an amount of a thermal sensitizing agent that is effective to enhance the decomposition rate of the oligomeric component in the presence of radiation.

17. The release layer composition of claim 1, further comprising an amount of a low molecular weight additive that vaporizes under conditions at which the oligomeric component decomposes in the presence of radiation.

18. A release layer comprising the release layer composition of claim 1.

19. An assembly, comprising the release layer of claim 18 disposed over a donor plate.

20. The assembly of claim 19, further comprising a plurality of components in contact with the release layer.

21. A method of forming a transfer assembly, comprising:
disposing a release layer over a donor plate, wherein the release layer comprises an oligomeric component that comprises a unit of the Formula (I) and/or Formula (II): 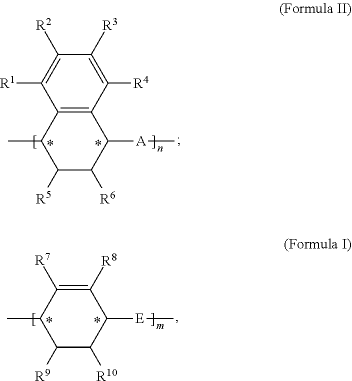
wherein:
each * denotes a chiral carbon;
n and m are independently an integer in the range of 1 to 15;
each A and E are independently —O—, —NH—, 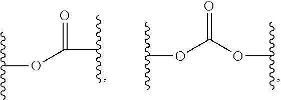 [SMILES: *OC(*)=O ; *OC(=O)O*]
an optionally substituted 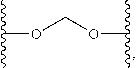 [SMILES: *OCO*]
an optionally substituted 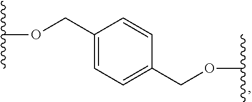 [SMILES: *OCc1ccc(CO*)cc1]
an optionally substituted 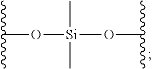 [SMILES: *O[Si](C)(C)O*]
an optionally substituted 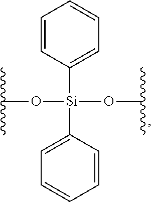 [SMILES: *O[Si](O*)(c1ccccc1)c1ccccc1]
an optionally substituted 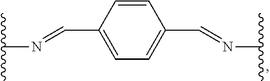 [SMILES: */N=C/c1ccc(/C=N/*)cc1]
an optionally substituted 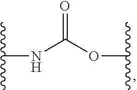 [SMILES: *NC(=O)O*]
an optionally substituted 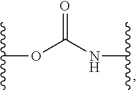 [SMILES: *NC(=O)O*]
an optionally substituted 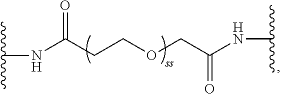
an optionally substituted 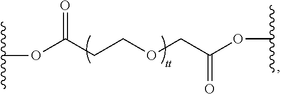
an optionally substituted 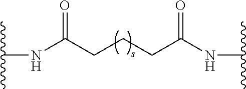
or an optionally substituted 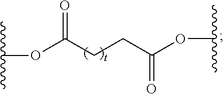
each R¹, R², R³, R⁴, R⁵, R⁶, R⁷, R⁸, R⁹ and R¹⁰ are independently hydrogen, halogen, C₁₋₁₀ alkyl, C₂₋₁₀ alkenyl or C₂₋₁₀ alkynyl; and
each ss, tt, s and t are independently an integer in the range of 1 to 10;
and
contacting the release layer with a plurality of components to form the transfer assembly.

22. A method of transferring a plurality of components, comprising:
disposing a transfer assembly over a receiving substrate, wherein the transfer assembly comprises a donor plate, a release layer disposed over the donor plate, and a plurality of components in contact with the release layer, and wherein the release layer comprises an oligomeric component that comprises a unit of the Formula (I) and/or Formula (II): 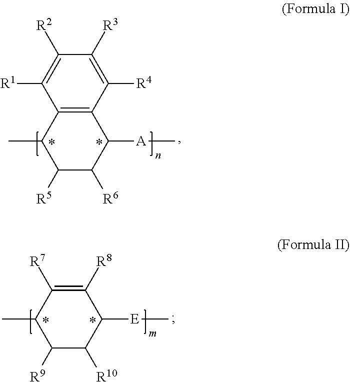
wherein:
each * denotes a chiral carbon;
n and m are independently an integer in the range of 1 to 15;
each A and E are independently —O—, —NH—, 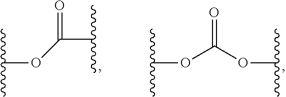 [SMILES: *OC(*)=O ; *OC(=O)O*]
an optionally substituted 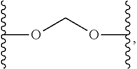 [SMILES: *OCO*]
an optionally substituted 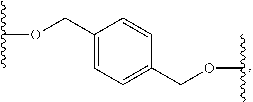 [SMILES: *OCc1ccc(CO*)cc1]
an optionally substituted 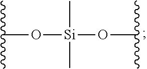 [SMILES: *O[Si](C)(C)O*]
an optionally substituted 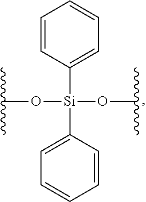 [SMILES: *O[Si](O*)(c1ccccc1)c1ccccc1]
an optionally substituted 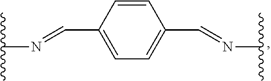 [SMILES: */N=C/c1ccc(/C=N/*)cc1]
an optionally substituted 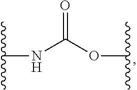 [SMILES: *NC(=O)O*]
an optionally substituted 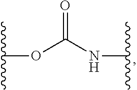 [SMILES: *NC(=O)O*]
an optionally substituted 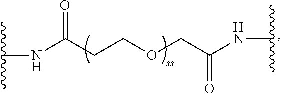
an optionally substituted 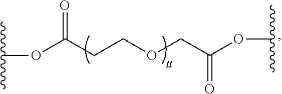
an optionally substituted 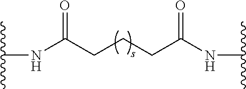
or an optionally substituted 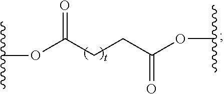
each R¹, R², R³, R⁴, R⁵, R⁶, R⁷, R⁸, R⁹ and R¹⁰ are independently hydrogen, halogen, C₁₋₁₀ alkyl, C₂₋₁₀ alkenyl or C₂₋₁₀ alkynyl; and
each ss, tt, s and t are independently an integer in the range of 1 to 10;
exposing portions of the release layer in contact with the plurality of components to a radiation source;
heating the release layer; and
degrading the portions of the release layer in contact with the plurality of components thereby transferring the plurality of components to the receiving substrate.
